(19) United States
(12) Patent Application Publication
(10) Pub. No.: US 2010/0153887 A1
(43) Pub. Date: Jun. 17, 2010

(54) PRESENTATION SYSTEM, DATA MANAGEMENT APPARATUS, AND COMPUTER-READABLE RECORDING MEDIUM

(75) Inventors: Takehisa Yamaguchi, Ikoma-shi (JP); Minako Kobayashi, Ikeda-shi (JP); Katsuhiko Akita, Amagasaki-shi (JP); Kazuya Anezaki, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/637,435

(22) Filed: Dec. 14, 2009

(30) Foreign Application Priority Data
Dec. 16, 2008 (JP) 2008-320176

(51) Int. Cl. G06F 3/048

(52) U.S. Cl. 715/854

(57) ABSTRACT

A presentation system comprises a data management apparatus for storing document data for presentation therein, a display device for displaying a plurality of pages contained in the document data, and a terminal device capable of performing communication with the data management apparatus. The terminal device sends request data for requesting attachment of an electronic sticky note to the document data to the data management apparatus via network communication according to an input from a listening user of the presentation. The data management apparatus determines a sticky-note attachment object page out of the plurality of pages, to which the electronic sticky note is to be attached, on the basis of page specifying data included in the request data. Then, the data management apparatus generates a file in which the electronic sticky note is attached to the determined sticky-note attachment object page.

This application is based on Japanese Patent Application No. 2008-320176 filed on Dec. 16, 2008, the contents of which are hereby incorporated by reference.

### BACKGROUND OF THE INVENTION

1. Field of the Invention

The present invention relates to a presentation system and a technique relating thereto.

2. Description of the Background Art

There exists a system used for a presentation that a presenter makes by using a display device such as a projector or the like.

In such a system, it is proposed to store documents for presentation (conference documents) in a server (see Japanese Patent Application Laid Open Gazette No. 2007-21777: Patent Document 1).

In most presentations, explanations are given with reference to documents each covering a plurality of pages.

Further, in such a presentation, in general, questions are made to the presenter in a question-and-answer session or the like after the explanation of the presenter is finished (or at a timing when each of some sections is finished).

For this reason, if listeners have questions during the presentation, the listeners often write the page numbers or the like of the relevant pages into paper notes or the like and specify the question points (noted points) by checking the written memos later when they ask questions.

Such an action is made in various scenes as well as in asking questions. Also in a case, for example, where an item to be referred to later (e.g., an important item) is found in a certain page, the page number or the like of the relevant page is written into a paper note and the point to be referred to (the noted point) is specified by checking the written memo later.

In such an action, however, in order to record the noted page (noted point) out of a plurality of pages, it is necessary for the listener to check the page number or the like on a display screen and write the number into a paper note. This prevents sufficient convenience.

In such a recording manner, it is necessary to prepare a paper note. Also this prevents sufficient convenience.

Furthermore, a paper note is sometimes lost.

Such a situation as discussed above markedly occurs especially when no conference document is given to the listeners in advance, and so on.

### SUMMARY OF THE INVENTION

To solve the above problems, it is an object of the present invention to provide a presentation system which allows listening users to easily and reliably record noted points and a technique relating thereto.

The present invention is intended for a presentation system. According to a first aspect of the present invention, the presentation system comprises a data management apparatus for storing document data for presentation therein, a display device for displaying a plurality of pages contained in the document data, and a terminal device capable of performing network communication with the data management apparatus, which sends request data for requesting attachment of an electronic sticky note to the document data to the data management apparatus via the network communication according to an input from a listening user of the presentation, and in the presentation system of the present invention, the data management apparatus has an acquisition part for acquiring the request data from the terminal device via the network communication, a determination part for determining a sticky-note attachment object page out of the plurality of pages, to which the electronic sticky note is to be attached, on the basis of page specifying data included in the request data, and a generation part for generating a file in which the electronic sticky note is attached to the sticky-note attachment object page determined by the determination part.

The present invention is intended for a data management apparatus capable of performing network communication with a terminal device. According to a second aspect of the present invention, the data management apparatus comprises a document data storage part for storing document data for presentation therein, an acquisition part for acquiring request data for requesting attachment of an electronic sticky note to the document data from the terminal device via the network communication, a determination part for determining a sticky-note attachment object page out of a plurality of pages contained in the document data, to which the electronic sticky note is to be attached, on the basis of page specifying data included in the request data, and a generation part for generating a file in which the electronic sticky note is attached to the sticky-note attachment object page determined by the determination part.

The present invention is intended for a computer-readable recording medium. According to a third aspect of the present invention, the computer-readable recording medium stores a program executed by a computer which is capable of performing network communication with a terminal device to cause the computer to perform the steps of a) acquiring request data for requesting attachment of an electronic sticky note to document data for presentation from the terminal device via the network communication, b) determining a sticky-note attachment object page out of a plurality of pages contained in the document data, to which the electronic sticky note is to be attached, on the basis of page specifying data included in the request data, and c) generating a file in which the electronic sticky note is attached to the sticky-note attachment object page determined in the step b).

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a system configuration diagram showing an overview of a presentation system in accordance with a first preferred embodiment;

FIG. 2 is a block diagram schematically showing a constitution of a data management apparatus (MFP);

FIG. 3 is a block diagram showing part of the constitution of FIG. 2 in more detail;

FIG. 4 is a block diagram schematically showing a constitution of a portable terminal;

FIG. 5 is a conceptual diagram showing a communication operation between the data management apparatus and the portable terminal;

FIGS. 6 to 8 are flowcharts showing an operation of the data management apparatus;

FIG. 9 is a conceptual diagram showing an exemplary communication operation between the data management apparatus and the portable terminal;

FIG. 10 is a view showing a display screen in a client computer;

FIG. 11 is a view showing another display screen in the client computer;

FIG. 12 is a conceptual diagram showing a display period management table;

FIG. 13 is a conceptual diagram showing request data;

FIG. 14 is a conceptual diagram showing electronic sticky note data;

FIG. 15 is a timing chart showing a relation between a display period of each page and a new creation timing of memo data;

FIG. 16 is a conceptual diagram showing a storage part for storing a file for each user;

FIGS. 17 to 22 are views each showing a display screen of the portable terminal;

FIG. 23 is a conceptual diagram on file generation;

FIG. 24 is a view showing a page layout;

FIG. 25 is a diagram showing a presentation system in accordance with a second preferred embodiment;

FIGS. 26 and 27 are views each showing a display screen of the portable terminal;

FIG. 28 is a timing chart showing a relation between a display period of each page and a new creation timing of the memo data;

FIG. 29 is a conceptual diagram showing request data;

FIG. 30 is a diagram showing a presentation system in accordance with a third preferred embodiment;

FIG. 31 is a view showing a display screen of the portable terminal;

FIG. 32 is a conceptual diagram showing request data;

FIG. 33 is a timing chart showing a relation between a display period of each page and a new creation timing of the memo data;

FIG. 34 is a diagram showing a presentation system in accordance with a fourth preferred embodiment;

FIG. 35 is a conceptual diagram showing request data;

FIG. 36 is a conceptual diagram showing file data creation in accordance with a variation;

FIG. 37 is a conceptual diagram showing a page layout in accordance with the variation; and

FIG. 38 is a block diagram schematically showing a constitution of a data management apparatus in accordance with the variation.

### DESCRIPTION OF THE PREFERRED EMBODIMENTS

Hereinafter, the preferred embodiments of the present invention will be discussed with reference to figures.

### 1. The First Preferred Embodiment

1-1. System Configuration>

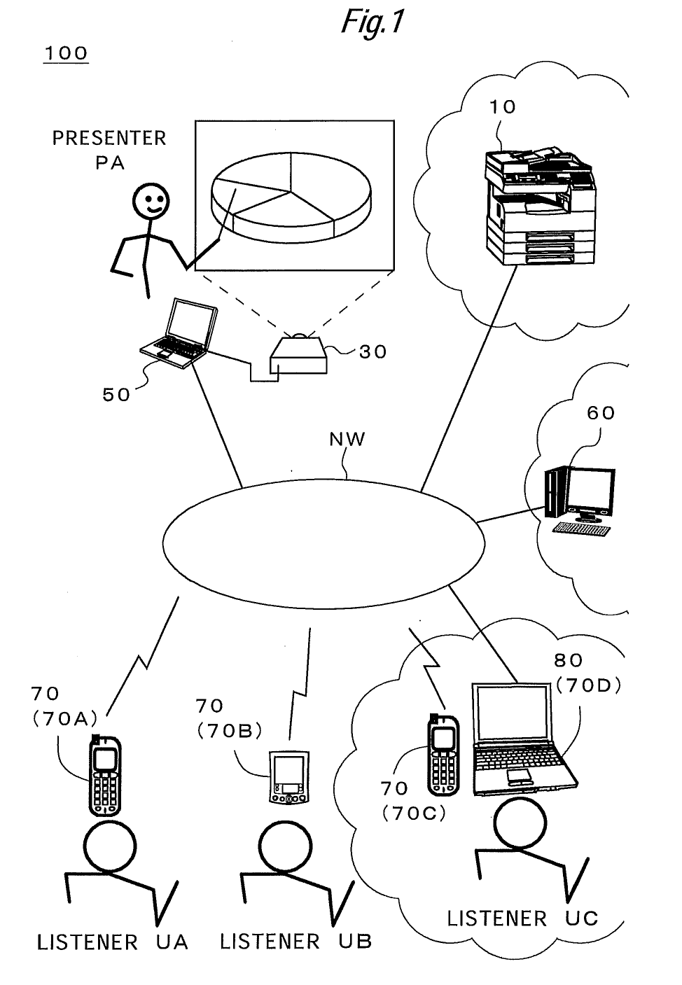

FIG. 1 is a system configuration diagram showing an overview of a presentation system 100 (100A) in accordance with the first preferred embodiment. The presentation system 100 is also referred to as a teleconference system. The system 100 comprises a data management apparatus (also referred to as a server computer or simply as a server) 10, a display device 30, client computers (also referred to simply as clients) 50 and 80, and a plurality of portable terminals 70.

The data management apparatus 10, the clients 50 and 80, and the portable terminals 70 are connected to one another via a network NW and capable of performing network communication. The network NW includes a LAN, a WAN, the internet, and the like. The connection between each of the devices and the network NW may be a wired connection or a wireless connection.

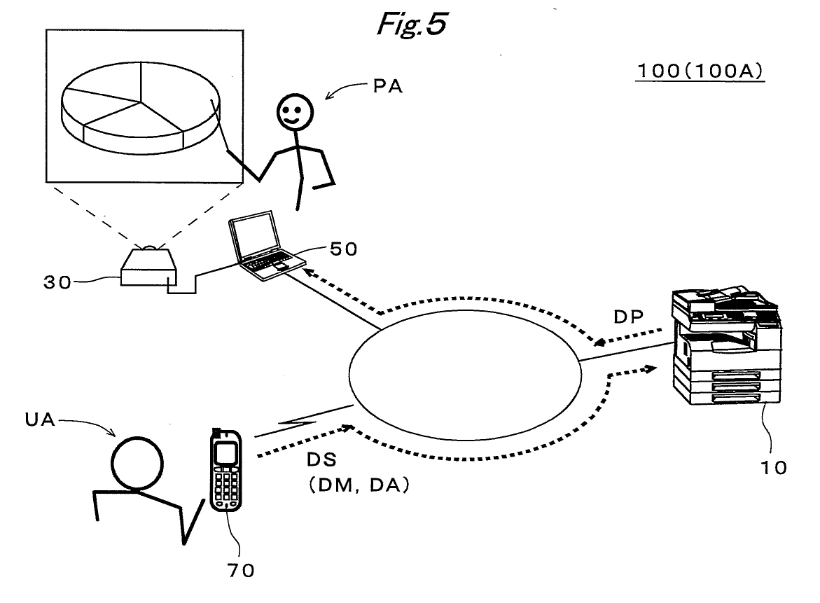

The data management apparatus 10 manages document data DP for presentation (see FIG. 5). The data management apparatus 10 stores the document data DP therein and delivers each of page images and the like relating to the document data DP to the client computer 50 of the presenter PA and the like.

The display device 30 displays the document data (document data for presentation) DP. Herein, the display device 30 is connected to a video signal output part (specifically, an external output terminal) of the client 50. When the client 50 acquires the page image on the document data DP from the data management apparatus 10, the page image is outputted from the video signal output part of the client 50 and inputted to a video signal input part of the display device 30. The page image is displayed by the display device 30. Thus, a plurality of pages contained in the document data DP are delivered to the client 50 from the data management apparatus 10 and displayed by the display device 30 via the client 50. As the display device 30, for example, used is a projector device or the like. Listeners of the presentation (especially, listeners UA, UB, . . . who are present in the meeting place for the presentation) can visually recognize the document data DP by an image displayed by the display device 30 (specifically, an image projected on a screen by the projector).

Further, the display device 30 sequentially displays a plurality of pages contained in the document data DP in response to an instruction input from the presenter PA via the client 50. The display operation of the display device 30 is performed under the control of the data management apparatus 10 via the client 50.

Each of the portable terminals (also referred to as “portable terminal devices”) 70 is capable of performing network communication with the data management apparatus 10. As each of the portable terminals 70, for example, used is a cellular phone, a mobile data terminal (also referred to as a PDA (Personal Data Assistance), a mobile personal computer, or the like.

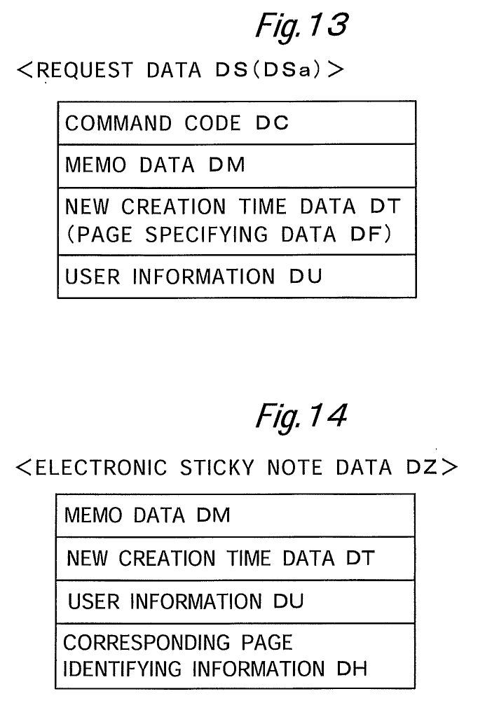

The portable terminals 70 (specifically, 70A, 70B, 70C, . . . ) send electronic sticky note request data DS (see FIGS. 5 and 13) to the data management apparatus 10 via the network NW according to respective inputs from a plurality of listeners (listening users) UA, UB, UC, . . . of the presentation. The electronic sticky note request data (hereinafter, referred to simply as “request data”) DS is data for requesting attachment of an electronic sticky note to the document data. As discussed later, the request data DS includes memo data DM to be electronically attached to an object page, and the like.

Thus, the listeners UA, UB, UC, . . . can send the request data DS to the data management apparatus 10 by using the portable terminals 70 that the listeners have, respectively. Discussing in more detail, the memo data DM relating to an important point and/or a question point in the document data DP, and the like, can be sent. As the memo data DM, for example, used is text data.

The listener UC (see FIG. 1) who is present in a meeting place different from the place where the presenter is present (referred to as a listener at a remote place) can visually recognize the document data (more specifically, the page images) delivered to the client 80 of the listener UC from the data management apparatus 10 via the network NW. Discussing in detail, the listener UC can visually recognize the document data by using an image displayed on a display part of the client 80. At that time, the display part of the client 80 serves as a display device for presentation. In such a situation, the listener at a remote place can send the request data DS to the data management apparatus 10 by using the portable terminal 70, referring to the presentation screen displayed on the client 80. Alternatively, the listener at a remove place may send the request data DS to the data management apparatus 10 by using the client 80 itself, instead of using the portable terminal 70. In summary, the client 80 may serve as a terminal device for sending the request data DS on the document data to the data management apparatus via the network. In other words, the request data DS on the document data may be sent to the data management apparatus 10 by using the portable terminal 70 or may be sent to the data management apparatus 10 by using the client 80.

The data management apparatus 10 receives the request data DS from the portable terminal 70 or the like via the network. Then, the data management apparatus 10 determines a page out of a plurality of pages contained in the document data DP, to which the electronic sticky note is to be attached, on the basis of the page specifying data DF (referred to as associating information) included in the request data DS. The data management apparatus 10 generates a file in which the electronic sticky note is attached to the determined sticky-note attachment object page. Discussing in more detail, the data management apparatus 10 generates a file in which the memo data DM and the like are associated with the sticky-note attachment object page. With this, the listener can easily and reliably attach the electronic sticky note (specifically, memo data DM and the like) to a desired page in the document data. Hereafter, detailed discussion will be made on such a system as discussed above.

In the first preferred embodiment, the data management apparatus 10 has a configuration as an MFP (Multi Function Peripheral). The data management apparatus 10 (MFP) has a server function. Specifically, the data management apparatus 10 has a file server function and further has a WWW (World Wide Web) server function and an application server function.

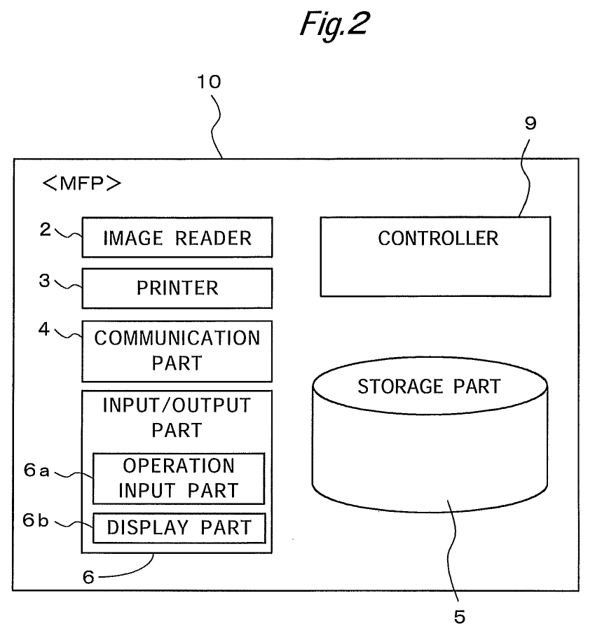

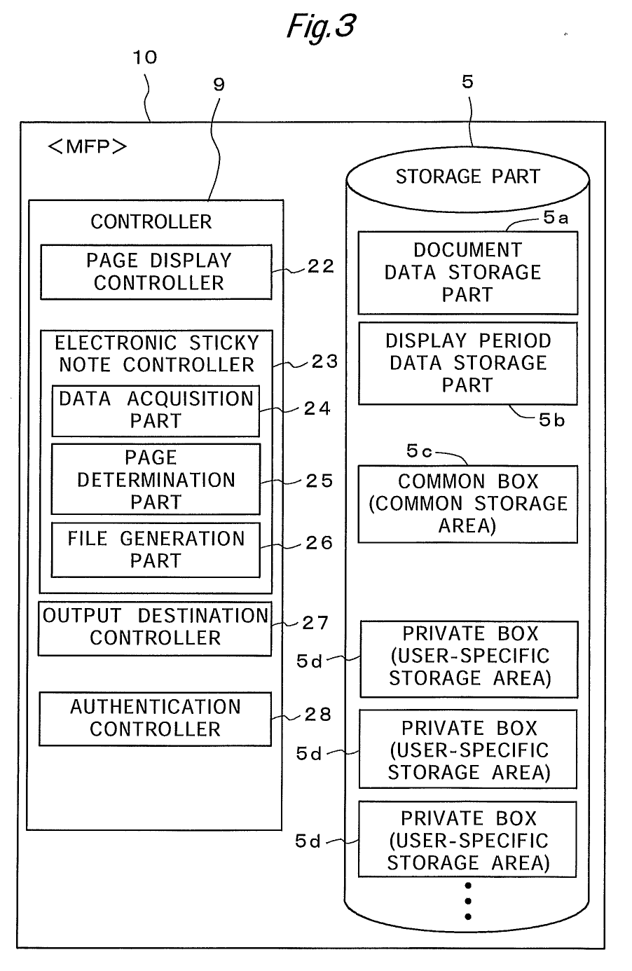

FIGS. 2 and 3 are block diagrams schematically showing a constitution of the data management apparatus (MFP) 10. FIG. 3 is a diagram showing part of the constitution in more detail.

As shown in the block diagram of FIG. 2, the data management apparatus (MFP) 10 comprises an image reader (an image reader part) 2, a printer (a printout part) 3, a communication part 4, a storage part 5, an input/output part 6, a controller 9, and the like, and multiply operates these constituent parts to implement various functions.

The image reader 2 is a processing part for optically reading an original manuscript placed o a predetermined position of the MFP 10 and generating image data of the original manuscript (also referred to as a manuscript image).

The printer 3 is an output part for printing out the image to any one of various types of media such as paper or the like on the basis of the data on an object to be printed.

The communication part 4 is a processing part capable of performing facsimile communication via a public network or the like. Further, the communication part 4 is capable of performing network communication via a communication network NW. The network communication uses various protocols such as TCP/IP (Transmission Control Protocol/Internet Protocol), FTP (File Transfer Protocol), and the like. By using the network communication, the MFP 10 can send and receive various data to/from a desired partner.

The storage part 5 is a storage device such as a hard disk drive (HDD) or/and the like. In the storage part 5, the manuscript image (image data) generated by the image reader 2 or the like is stored. Further, the storage part 5 stores the document data DP and the like therein.

The input/output part 6 comprises an operation input part 6a for receiving an input which is given to the MFP 10 and a display part 6b for displaying out various information.

The controller 9 is a control device incorporated in the MFP 10, for generally controlling the MFP 10, The controller 9 has a configuration as a computer system comprising a CPU, various semiconductor memories (RAM, ROM, and the like), and the like. The controller 9 causes the CPU to execute a predetermined software program (hereinafter, also referred to simply as a program) stored in the ROM (e.g., EEPROM or the like), to thereby implement various processing parts. Further, the program may be provided via a network or from a predetermined computer-readable recording medium (e.g., a USB memory (portable memory), a CD-ROM or the like).

Specifically, as shown in FIG. 3, the controller 9 implements various processing parts including a page display controller 22, an electronic sticky note controller 23, an output destination controller 27, and an authentication controller 28. The electronic sticky note controller 23 has a data acquisition part 24, a page determination part 25, and a file generation part 26. Operations of these processing parts will be discussed later in detail.

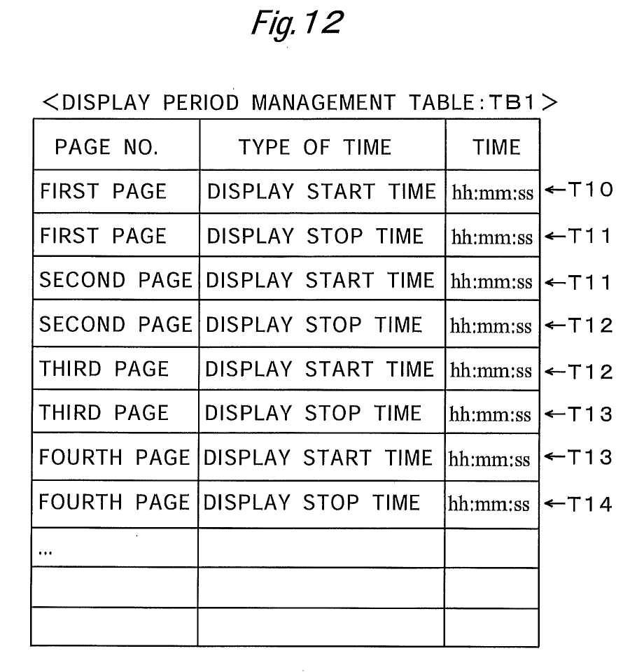

The storage part 5 has a document data storage part 5a and a display period data storage part 5b. The document data storage part 5a stores the document data DP therein. The display period data storage part 5b stores data table (display period management table) TB1 (see FIG. 12) therein. In the data table TB1, recorded is data (display period data) indicating a period (display period) while each of a plurality of pages contained in the document data DP is displayed for the presentation by the display device 30.

The storage part 5 further has one common box 5c and a plurality of private boxes 5d. The common box 5c is provided commonly to all the users and the private boxes 5d are provided individually to the users. As discussed later, in the private box 5d, stored is, for example, file data FL in which the electronic sticky note is already attached.

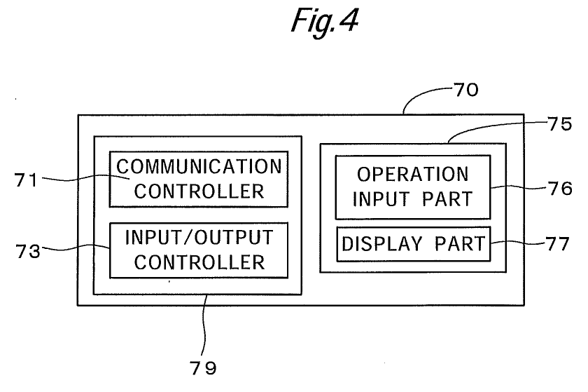

FIG. 4 is a block diagram schematically showing a constitution of the portable terminal 70. As shown in FIG. 4, the portable terminal 70 comprises an input/output part 75 and a controller 79.

The input/output part 75 has an operation input part (terminal-side operation input part) 76 for receiving an input given to the portable terminal 70 and a display part (terminal-side display part) 77 for displaying out various information. For example, a plurality of key buttons are provided as the operation input part 76 and a liquid crystal panel is provided as the display part 77. Alternatively, an operation panel 78 (not shown) serving as both the display part 77 and the operation input part 76 may be provided as the input/output part 75. Such an operation panel 78 has a configuration, for example, in which a piezoelectric sensor or the like is embedded in the liquid crystal panel.

The controller 79 implements various processing parts including a communication controller 71 and an input/output controller 73.

The input/output controller 73 is a control part for controlling an operation of the input/output part 75. Specifically, the input/output controller 73 controls an operation of receiving an operation input from a user by using the operation input part 76 and a display operation of the display part 77.

The communication controller 71 is a control part for controlling a network communication operation. The communication controller 71 also controls a communication operation using the telephone line.

<1-2. Outline of Operation>

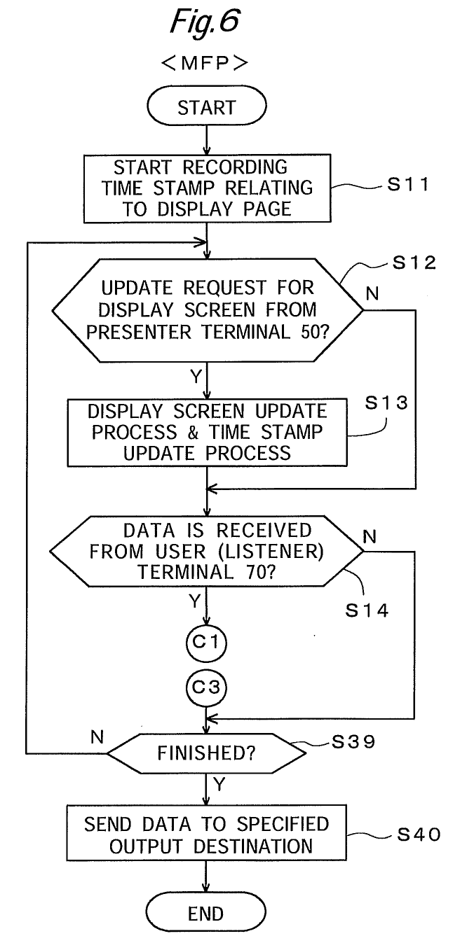

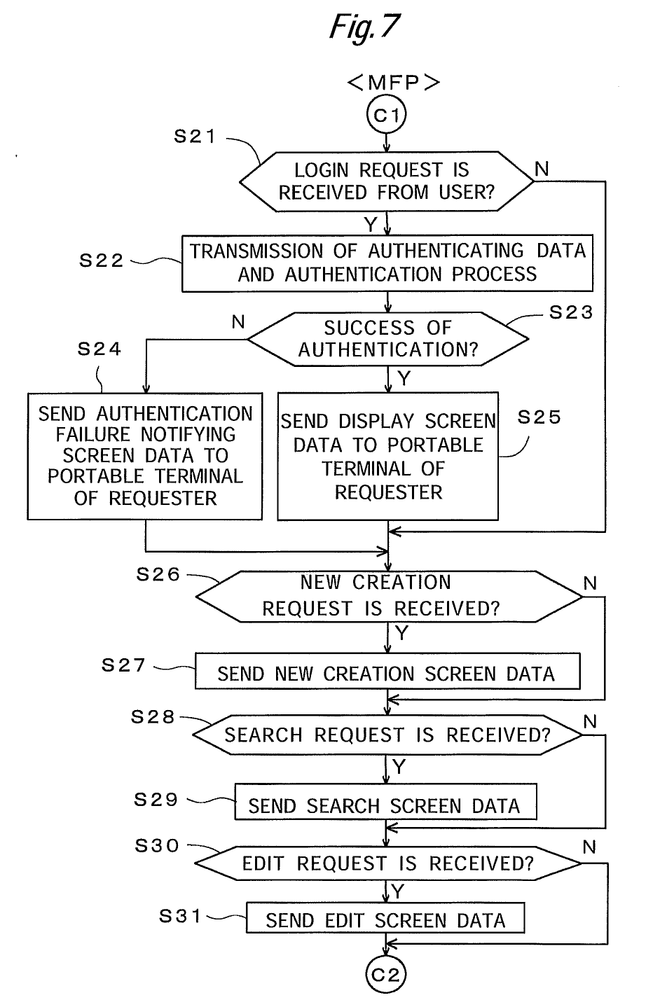

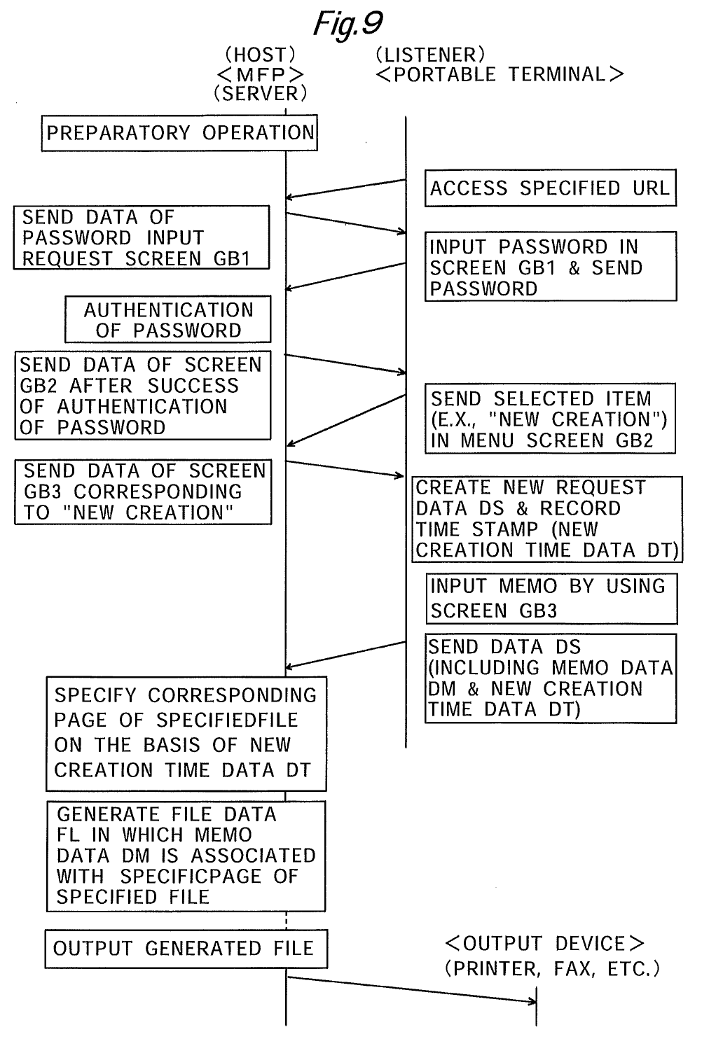

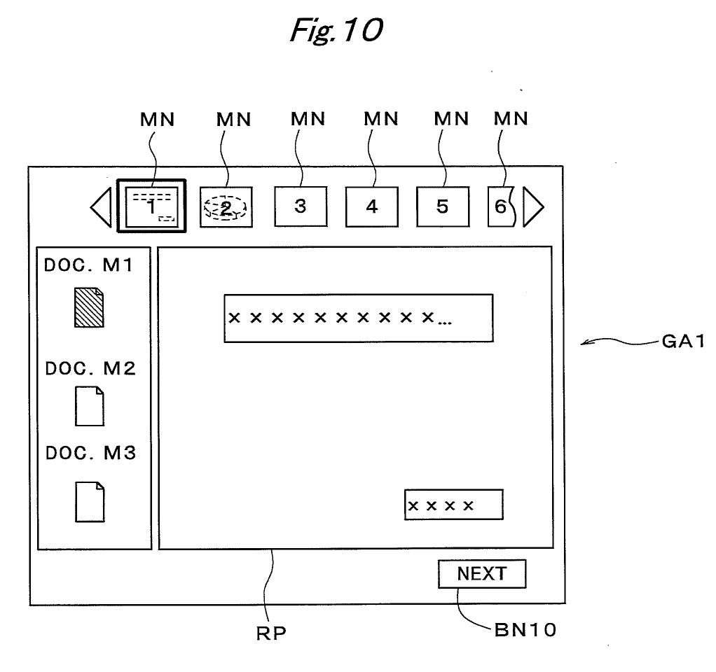

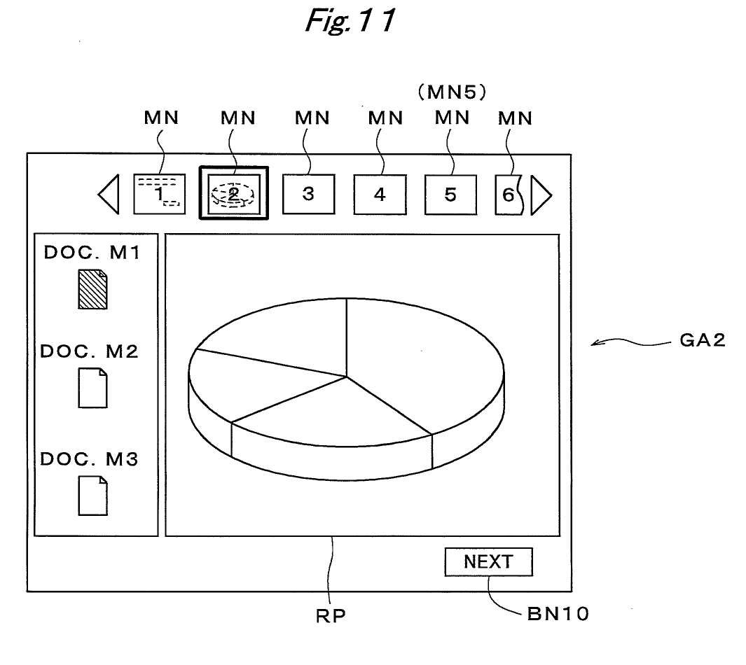

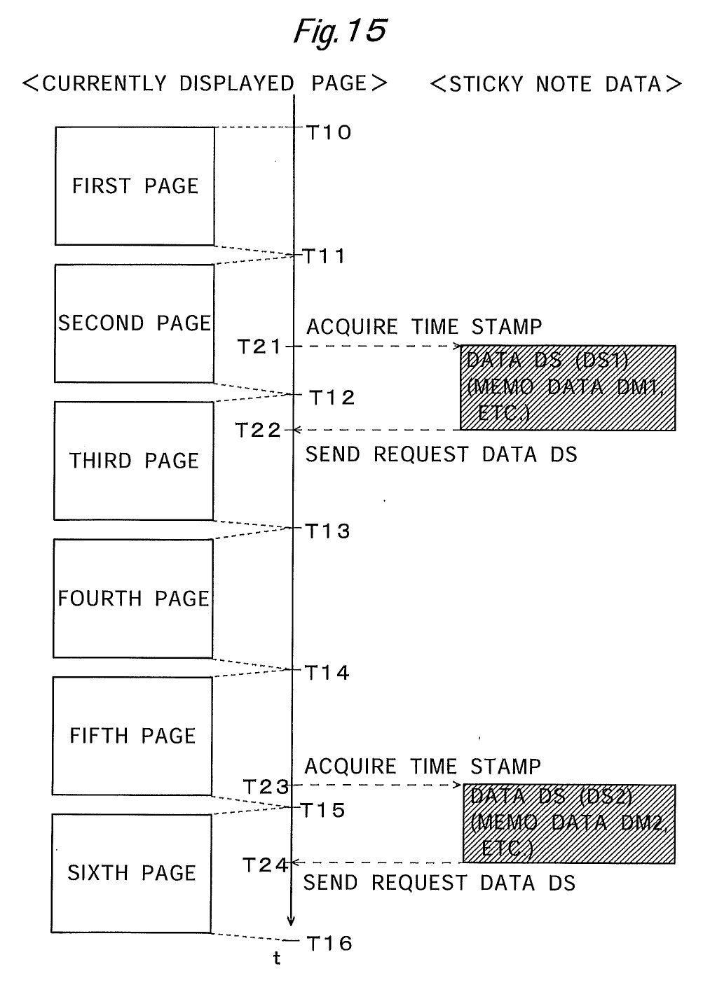

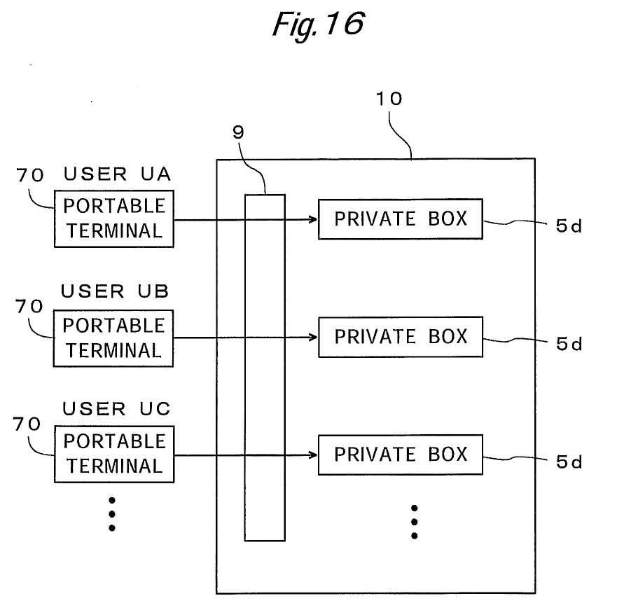

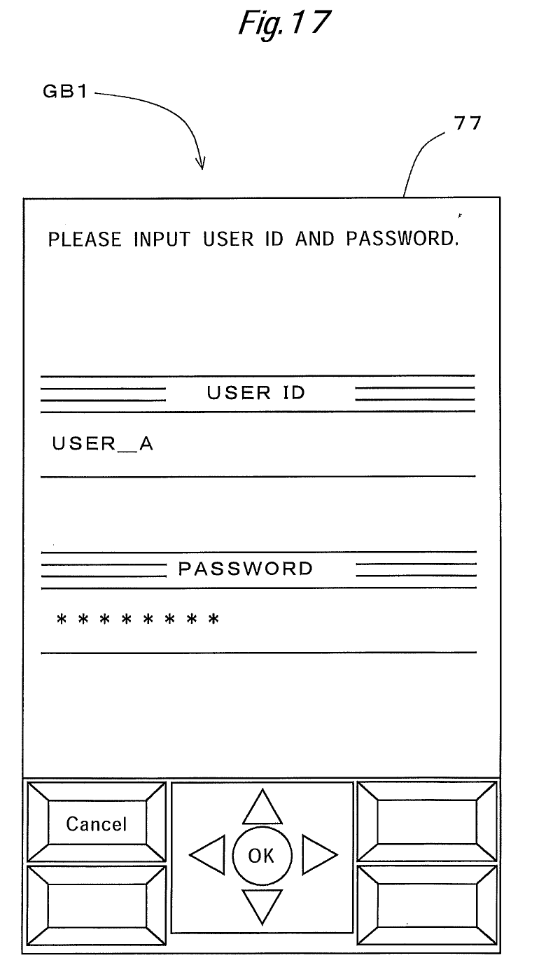

FIGS. 6 to 8 are flowcharts showing an operation of the data management apparatus 10, and FIG. 9 is a diagram showing an exemplary communication operation between the data management apparatus 10 and the portable terminal 70. FIGS. 10 and 11 are views showing display screens GA1 and GA2, respectively, on the client 50. FIG. 12 is a diagram showing the display period management table TB1 stored in the display period data storage part 5b (see FIG. 3). FIG. 13 is a diagram showing the request data DS (DSa) transmitted from the portable terminal 70 to the data management apparatus 10, and FIG. 14 is a diagram showing electronic sticky note data DZ generated according to the request data DS and to be attached to the file. FIG. 15 is a timing chart showing a relation between a display period of each of the pages for presentation and a new creation timing of the request data DS. FIG. 16 is a diagram showing a storage part for storing a file generated in accordance with the transmission of the request data DS from each user. FIGS. 17 to 22 are views showing display screens GB1 to GB6 on the portable terminal 70, respectively, at each point in time.

Next, with reference to these figures, an operation of the system 100 will be discussed. Hereafter, discussion will be made along the flowcharts of FIGS. 6 to 8.

Hereinafter, it is assumed that an entry operation of the document data DP, an entry operation of listener data, an entry operation of the private box, and the like in the data management apparatus 10 have been already finished by a host user (e.g., the presenter PA or an assistant user on the host side).

The entry operation of the document data DP includes an entry operation of documents used in the presentation. For example, the host user has only to operate the data management apparatus 10 to store the documents to be used (e.g., a plurality of documents M1 to M3) into the document data storage part 5a (see FIG. 3) in advance. The documents M1 to M3 may be data files of the same application software, or may be data files of different application softwares.

The entry operation of the listener data includes an entry operation of a user ID and a password of each listener. For example, the host user has only to operate the data management apparatus 10 to enter the user information (the user ID and the password) of each listener. It is assumed that the user information (user entry information) of each listener has been delivered to the listener in advance by mail. Each listener can perform a user authentication operation by using the delivered user information.

The entry operation of the private box includes an operation of reserving a private area for each listener. For example, the host user has only to operate the data management apparatus 10 to reserve an area (“private box”) 5d for storing a file generated for each user in the storage part 5 of the data management apparatus 10. The private box 5d for each listener is a storage area accessible only to that listener besides a system administrator. The common box 5c in the storage part 5 is created as a default area in advance.

After these entry operations are finished, a presentation is started by the presenter PA from a predetermined time T10 (see FIG. 15) and the operations shown in FIGS. 6 to 8 are performed. In the data management apparatus 10, in response to the requests from the client 50, the portable terminal 70, and the like, the operations according to the requests are performed. Discussing in detail, a process for determining the type of request is performed in Steps S12, S14, S21, S26, S28, S30, S32, and S36, and after that, a process according to the type of request is performed. In the data management apparatus 10, the operations of Steps S12 to S39 are performed repeatedly at intervals of very short time.

<1-3. Presentation Display Update Process>

When a predetermined start instruction is sent from the client 50 to the data management apparatus 10, data of the first screen GA1 is sent to the client 50 and the screen GA1 (see FIG. 10) is displayed on the display part of the client 50. Receiving the start instruction, the data management apparatus 10 detects that the presentation starts.

Using the screen GA (GA1, GA2, . . . ) (see FIGS. 10 and 11) displayed on the client 50, the presenter PA can causes the presentation to proceed while changing the display page. Each screen GA (GA1, GA2, . . . ) is also displayed by the display device 30 via the client 50.

On the left side of the screen GA (GA1) shown in FIG. 10, arranged are a plurality of documents M1 to M3 which are entered as the document data DP in advance, and on the upper side of the screen GA, respective thumbnail images MN of the pages in each of the documents M1 to M3 are arranged from left to right in order of page. By manipulation of a mouse or the like, the presenter PA can select any one of the documents M1 to M3 contained in the document data DP as a document for presentation and select a desired page in the document as a file to be displayed. In the screen GA, by changing a display color for the selected document M1 and enclosing the selected thumbnail image MN with a thick line, the selection state is indicated. In a page display area RP at the center of the screen GA, the currently selected page is displayed.

In the first preferred embodiment, at the presentation start time T10, the data management apparatus 10 automatically selects the first page of the first document M1 as the page to be displayed. Then, the data management apparatus 10 sends the image data of the first page and respective thumbnail image data of a plurality of pages near the first page (e.g., the first page to the sixth page) to the client 50. The client 50 displays the screen GA1 in which the image data is arranged in a predetermined layout by using the display device 30.

In FIG. 10, shown is a situation where the first document M1 is selected out of the documents M1 to M3 contained in the document data DP and the first page of the first document M1 is further selected in such an initial state. In the screen GA1, the selected first page is displayed in the large page display area RP at the center of the screen.

The data management apparatus 10 starts recording a time stamp relating to the screen to be displayed by the display device 30 from the presentation start time T10 (Step S11). For example, in the display period management table TB1 (see FIG. 12) in the display period data storage part 5b (see FIG. 3), the display start time T10 of the first page is recorded.

After that, the presenter PA can change the page to be displayed by using the screen GA1 (see FIG. 10). Specifically, by pressing a button BN10 (“NEXT” button) i the screen GA1, the presenter PA can select the second page of the document M1 as the page to be displayed.

When the button BN10 is pressed, the client 50 sends an update request for the display page to the data management apparatus 10. This update request includes page identifying information for identifying the page to be displayed. In this case, the page identifying information has only to include, for example, a combination of the document number of the document to be displayed (e.g., the document number of the document “M1”) and the page number in the document to be displayed (e.g., “the second page”). Alternatively, the page identifying information may specify the page by using a “serial number” uniquely given to each of all the pages of the plurality of documents (M1 to M3). For example, the Pi-th page of the second document M2 may be represented by the total serial number (=PL+Pi) obtained by adding Pi to the last page number PL of the first document.

Receiving the update request for the display page (Step S12), the data management apparatus 10 performs an update process for updating the display screen in response to the update request and an update process for updating the time stamp (Step S13).

Specifically, the data management apparatus 10 sends the image data on the updated page (herein, the second page) and the thumbnail image data on a plurality of pages near the second page (herein, the first page to the sixth page) to the client 50. On the other hand, the client 50 displays the screen GA2 (see FIG. 11) according to the received data. In the screen GA2 of FIG. 11, the received image data is arranged in a predetermined layout. Further, in the screen GA2, shown is a situation where the first document M1 is selected out of the documents M1 to M3 contained in the document data DP and the second page of the first document M1 is further selected.

The data management apparatus 10 records a time T11 as the display stop time of the first page and also records the time T11 as the display start time of the second page in the display period management table TB1 (see FIG. 12) in the display period data storage part 5b (see FIG. 3).

After that, by repeating the same operation as above, the presenter PA can cause the presentation to proceed while changing the page to be displayed. Particularly, in the operation of updating the page to be displayed, both the operation of recording the display stop time of the page before the update and the operation of recording the display start time of the updated page are performed. With this, with respect to each of the pages contained in the document data DP, the period for display by the display device 30 (the display start time and the display stop time of each page) is recorded.

The presenter PA may determine a desired page as the page to be displayed next by pressing one of a plurality of thumbnail images arranged in the upper portion of the screen GA, which corresponds to the desired page. Specifically, when one thumbnail image (e.g., MN5) in the screen GA is selected by manipulation of the mouse (e.g., double click), the client 50 sends a display request for requesting that the page corresponding to the thumbnail image should be displayed to the data management apparatus 10. Then, receiving the display request (update request) (Step S12), the data management apparatus 10 performs an update process for changing the display screen to a specified screen and an update process for updating the time stamp (Step S13) in response to the display request.

In order to change the document to be displayed from the document M1 to another document M2, M3, or the like, the presenter PA has only to select a desired document (e.g., M2) on the left side of the screen GA. With this, the client 50 sends a display request for an initial page (e.g., the first page) of the desired document M2 to the data management apparatus 10. Further, the data management apparatus 10 sends data for displaying the specified page (e.g., the first page) of the document M2 in response to the display request.

The above operations are performed by the page display controller 22 and the like.

In other words, the page display controller 22 (see FIG. 3) controls a display update operation for outputting an image of each page (page image) of the document data DP to the client 50 and the like. Specifically, when the presenter PA operates the client 50 to send the display request of each page image (the update request of each page) from the client 50 to the data management apparatus 10, the page display controller 22 receives the display request from the client 50. Receiving the display request, the page display controller 22 sends the data of each page image to the client 50 in response to the display request. Then, by sending the data to the client 50, the desired page is displayed by the display device 30.

The page display controller 22 also controls the operation of recording the display period of each page into the display period management table TB1 (recording operation of the display period).

<1-4. Authentication Process>

After the presentation start time T10, the system 100 can perform an electronic sticky note attachment operation concurrently with the display update operation and the display period recording operation discussed above. The electronic sticky note attachment operation is implemented by communication between the portable terminal 70 of each listener and the data management apparatus 10.

The listener (e.g., the user UA) who has an intention of performing the electronic sticky note attachment operation first performs a user authentication operation. Specifically, by using a web access function of the portable terminal 70, the listener accesses a predetermined URL (Uniform Resource Locator). As the URL, specified is an address of a user authentication screen in the data management apparatus 10 (WWW server).

When the data management apparatus 10 accesses the URL, or in other words, receives a login request from the user (Step S21), the data management apparatus 10 sends data of the user authentication screen to the portable terminal 70 (Step S22). As a result, such a user authentication screen GB1 as shown in FIG. 17 is displayed on the display part 77 of the portable terminal 70.

The user UA inputs his own user information (user ID and password) by using the operation input part 76 of the portable terminal 70 and thereafter inputs an OK (determination) instruction (send instruction). The portable terminal 70 sends the inputted user information (user authentication information) to the data management apparatus 10 in response to the input.

Receiving the user authentication information from the portable terminal 70, the data management apparatus 10 performs an authentication operation (Step S22). Specifically, if the combination of the user ID and the password (input data) agrees with the combination of the user ID and the password (normal data) which is stored in the data management apparatus 10 in advance, the authentication controller 28 (see FIG. 3) judges the case as “success of authentication”. On the other hand, if the input data does not agree with the normal data, the authentication controller 28 judges the case as “failure of authentication”.

If the case is judged as “failure of authentication”, the authentication controller 28 sends the authentication result to the portable terminal 70 (Steps S23 and S24). In response to the received authentication result (failure of authentication), the display part 77 of the portable terminal 70 displays that it is a failure of authentication.

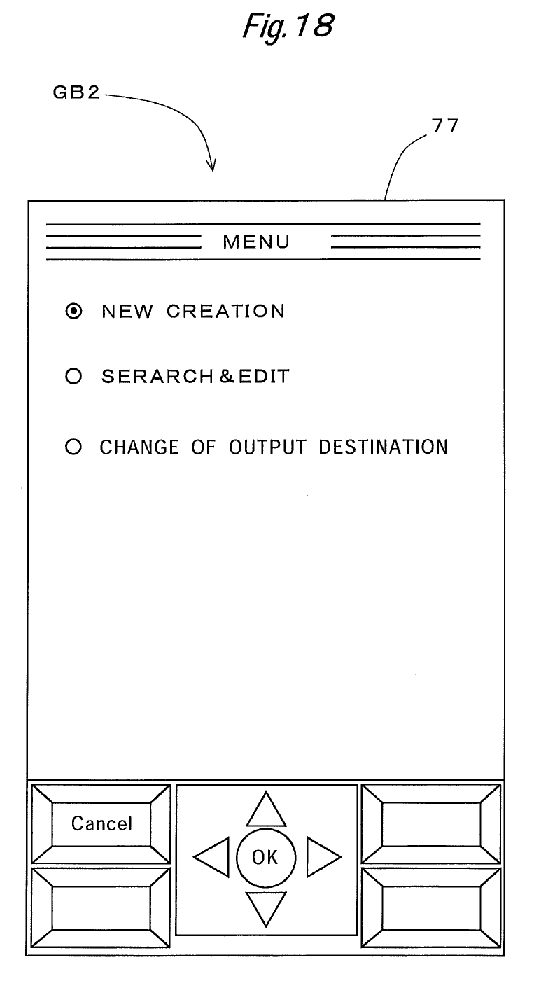

If the case is judged as “success of authentication”, the data management apparatus 10 (specifically, the authentication controller 28 and the electronic sticky note controller 23) sends data of a menu screen GB2 to the portable terminal 70 (Steps S23 and S25). As a result, such a menu screen GB2 as shown in FIG. 18 is displayed on the display part 77 of the portable terminal 70. In the menu screen GB2, three options, i.e., “new creation”, “search & edit”, and “change of output destination” are displayed.

The user UA selects a desired one of a plurality of options in the menu screen GB2 by using the operation input part 76 of the portable terminal 70. Hereafter, first, discussion will be made on the case where the “new creation” is selected.

<1-5. Electronic Sticky Note Attachment Process (New Creation)>

When the user UA performs a manipulation to select a radio button corresponding to the “new creation” and input the OK instruction (send instruction) in the menu screen GB2, the portable terminal 70 sends a “new creation request” for an electronic sticky note (memo data and the like) to the data management apparatus 10.

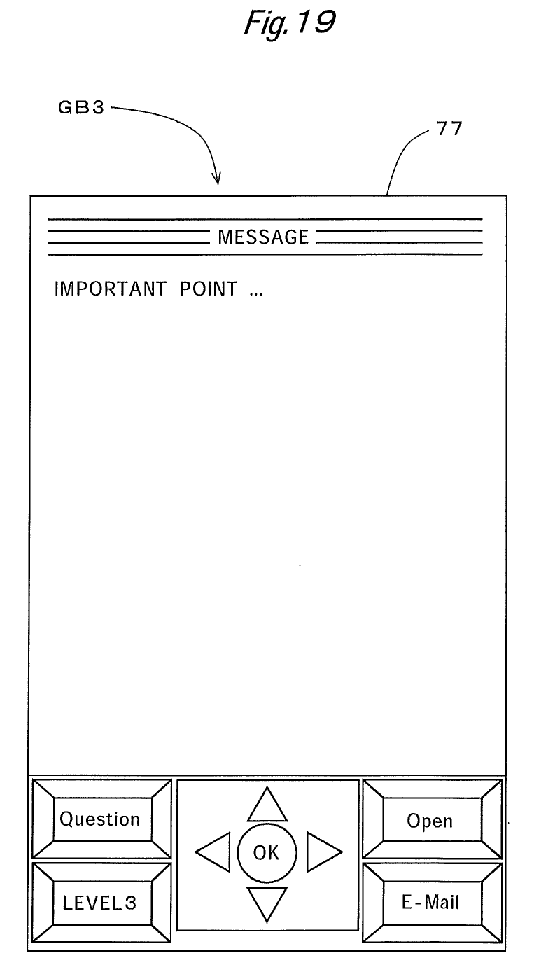

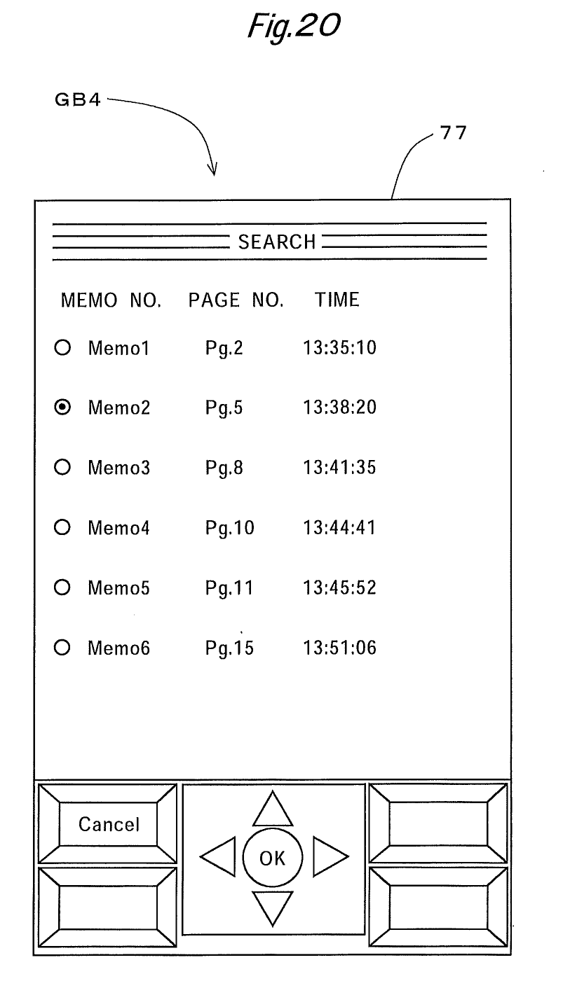

Receiving the new creation request from the portable terminal 70, the data management apparatus 10 (specifically, the electronic sticky note controller 23) sends data of a memo input (memo new creation) screen to the portable terminal 70 (Steps S26 and S27). As a result, such a memo input screen GB3 as shown in FIG. 19 is displayed on the display part 77 of the portable terminal 70. Further, the portable terminal 70 newly creates the request data DS (discussed later) at this point in time (e.g., at a time T21 (see FIG. 15)).

The user UA can newly input appropriate memo data by using the memo input screen GB3 and the operation input part 76. For example, the user UA has only to input that this page is an “important point”. Further, the user UA may write more detailed information. Alternatively, the user UA may input a question item.

When the user UA inputs the content of the memo on the memo input screen GB3 (see FIG. 19) and further inputs the OK instruction (send instruction), the portable terminal 70 confirms the content of the request data DS and sends the request data DS to the data management apparatus 10 in response to the inputs. In other words, the portable terminal 70 sends the request data DS to the data management apparatus 10 via the network according to the inputs from the listening user of the presentation.

With reference to FIG. 13, discussion will be made on the request data DS. The request data DS is data for requesting attachment of an electronic sticky note to the document data DP, indicating the detailed information on the electronic sticky note.

The request data DS includes electronic sticky note request command data DC giving an instruction to attach an electronic sticky note to the document data DP (specifically, a command code indicating the instruction). The electronic sticky note request command data (also referred to simply as “command data”) DC may be also represented as data indicating that an electronic sticky note should be attached to any one of the plurality of pages contained in the document data DP.

As shown in FIG. 13, the request data DS further includes memo data DM, page specifying data DF, and the user information DU.

The memo data DM includes memo information on any one of the plurality of pages contained in the document data DP. The memo data DM is herein text data and includes, for example, a character string “important point” inputted by the user UA in order to indicate that the content of the page is important.

The page specifying data DF is data to be used from specifying a sticky-note attachment object page to which the electronic sticky note is to be attached. In the first preferred embodiment, as exemplary page specifying data DF, new creation time data DT is used. The new creation time data DT is data indicating the new creation time of the request data DS on the electronic sticky note. For example, the new creation time is the point in time when the portable terminal 70 receives the data of the memo input screen (e.g., the time T21). The new creation time is not limited to this, but a time when a new creation instruction on the electronic sticky note is sent to the data management apparatus 10 by using the menu screen GB2 (exactly, a point in time immediately before the time T21) may be determined as the “new creation time” of the request data DS.

The user information DU includes information for identifying the listening user who requests the electronic sticky note. Specifically, the user information DU has information for identifying the user (the login user ID, temporary identifying information sent instead of the user ID, or the like).

Since the memo data DM, the page specifying data DF (the new creation time data DT), and the user information DU are data accompanying the command data DC, these data are also represented as “accompanying data” of the command data DC. Since the page specifying data DF (the new creation time data DT) and the user information DU are data accompanying the memo data DM, these data are also represented as “accompanying data” of the memo data DM.

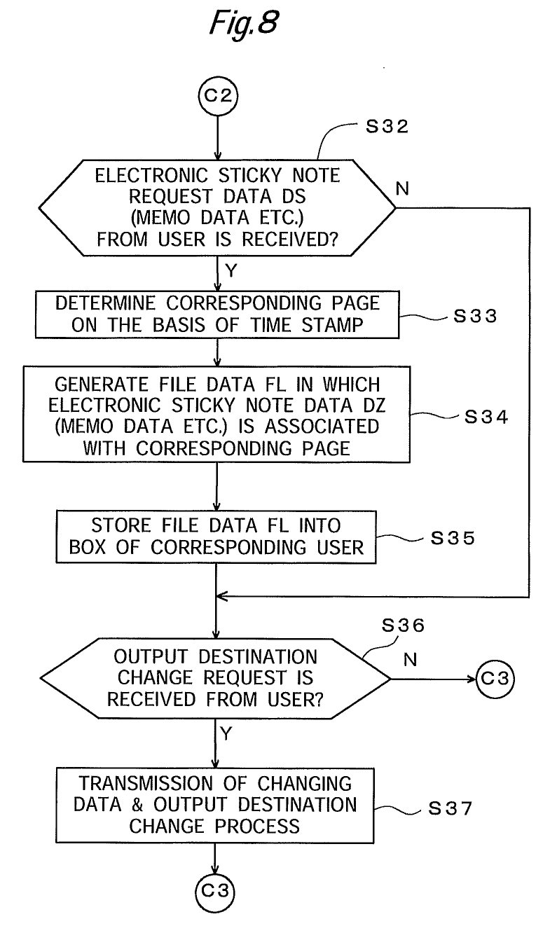

As shown in the flowchart of FIG. 8, when the data management apparatus 10 receives the request data DS from the portable terminal 70 via the network NW (Step S32), the data management apparatus 10 determines a “sticky-note attachment object page” (Step S33). Specifically, the data acquisition part 24 receives the request data DS and the page determination part 25 determines the “sticky-note attachment object page”.

The page determination part 25 selects and determines a “sticky-note attachment object page” with which the electronic sticky note (herein, including the memo data DM) is to be associated, out of a plurality of pages on the basis of the page specifying data DF (the new creation time data DT).

Discussing in more detail, the page determination part 25 determines the “sticky-note attachment object page” to which the electronic sticky note is to be attached on the basis of the “new creation time” contained in the new creation time data DT included in the request data DS and a “display period for each page” recorded in the display period management table TB1 (see FIG. 12). As shown in FIG. 15, since the time T21 exists between the display start time T11 of the second page and the display stop time T12 of the second page, it is determined that the memo data DM (DM1) newly created at the time T21 is data to be associated with the second page. In other words, it is determined that the “sticky-note attachment object page” relating to the request data DS1 (the memo data DM1 and the like) newly created at the time T21 is the second page. Similarly, it is determined that the “sticky-note attachment object page” relating to the request data DS2 (the memo data DM2 and the like) newly created at a time T23 is the fifth page. The time T23 exists between a display start time T14 of the fifth page and a display stop time T15 of the fifth page (T14<T23<T15).

Thus, if the new creation time of the request data DS exists between the display start time of a certain page and the display stop time thereof, the page is determined to be the “sticky-note attachment object page” relating to the request data DS. In other words, the data management apparatus 10 makes a judgment on specifying a display period which includes the new creation time of the request data DS out of a plurality of display periods corresponding to the plurality of pages, and the data management apparatus 10 determines the “sticky-note attachment object page” on the basis of a result of the judgment. Since the sticky-note attachment object page to which the electronic sticky note is to be attached is a page corresponding to the electronic sticky note, the page is also referred to as a “corresponding page”.

In this case, if the “corresponding page” is determined on the basis of the new creation time of the request data DS, the corresponding page (the sticky-note attachment object page to which the electronic sticky note is to be attached) of the request data DS can be correctly determined. For example, even if a send time T22 of the request data DS1 (the memo data DM1 and the like) relating the second page exists after the display stop time T12 of the second page, it is possible to correctly determine the corresponding page of the request data DS1. Discussing in more detail, even if it takes a relatively long time for the listener to write the memo relating to the second page and the presenter PA already starts an explanation on the next page (the third page) at the point in time T22 when the listener finishes writing the memo, it is possible to correctly determine the corresponding page of the request data DS1. In other words, the sticky-note attachment object page to which the electronic sticky note is to be attached can be correctly determined on the basis of the new creation time data and the display period data.

After that, the data management apparatus 10 (specifically, the file generation part 26) generates file data FL in which the electronic sticky note data DZ is associated with the “sticky-note attachment object page” determined by the page determination part 25 (Step S34). In other words, the file data FL is generated in the state where the electronic sticky note (specifically, the electronic sticky note data DZ) is attached to the sticky-note attachment object page out of the plurality of pages contained in the document data DP. The electronic sticky note data DZ is generated on the basis of the request data DS.

As shown in FIG. 14, herein, the electronic sticky note data DZ includes various data included in the request data DS. Specifically, the electronic sticky note data DZ includes the memo data DM, the new creation time data DT and the user information DU. Since the electronic sticky note data DZ is associated with the “corresponding page 47 (sticky-note attachment object page)” determined by the page determination part 25, the memo data DM may be also represented as data on the electronic sticky note which is associated with the sticky-note attachment object page.

Herein, the electronic sticky note data DZ also has information (corresponding page identifying information) DH on the “corresponding page (sticky-note attachment object page)” determined by the page determination part 25. The corresponding page identifying information DH is information indicating that, e.g., the “corresponding page” of the electronic sticky note data DZ1 is “the second page”. Herein, the electronic sticky note data DZ also includes the user information DU. The electronic sticky note data DZ, however, is not limited to this, but the electronic sticky note data DZ except the user information DU may be used.

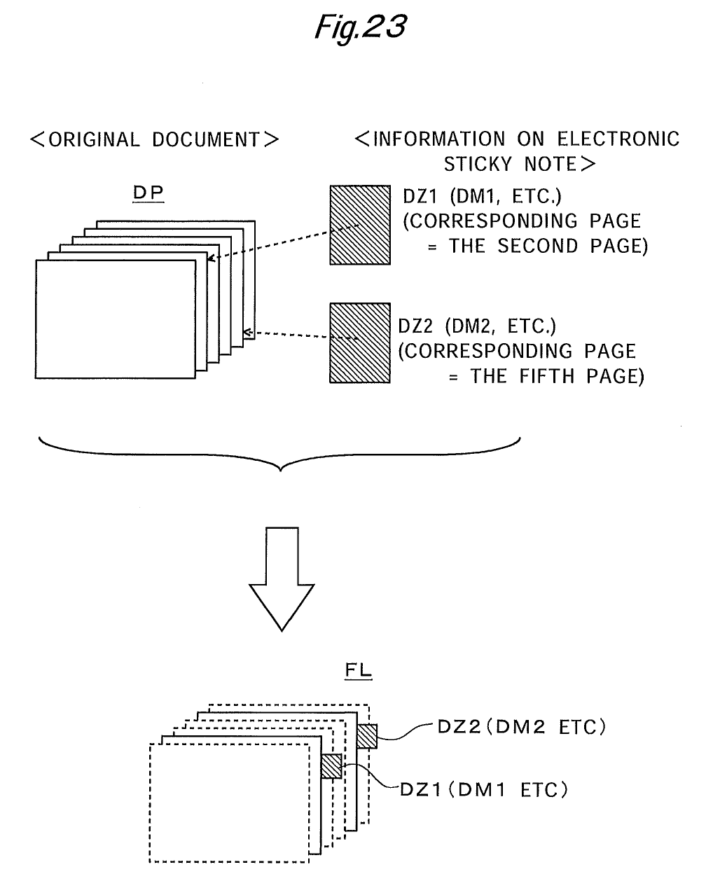

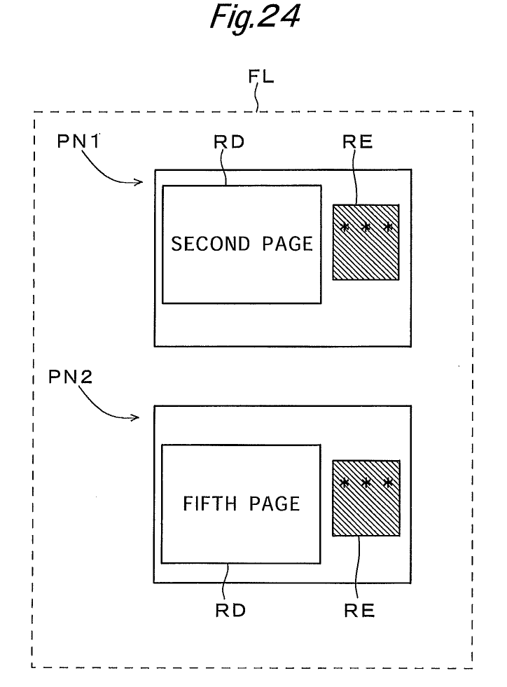

FIG. 23 is a conceptual diagram on file generation. FIG. 24 is a view showing a page layout in a file.

It is assumed herein, for example, that the electronic sticky notes are to be attached only to the second and fifth pages. In this case, as shown in FIG. 23, out of the document data DP (original documents), the electronic sticky note data DZ1 (the memo data DM1 and the like) is associated with the second page and the electronic sticky note data DZ2 (the memo data DM2 and the like) is associated with the fifth page.

Herein, the file generation part 26 extracts only the “corresponding page (sticky-note attachment object page)” out of the plurality of pages contained in the corresponding page DP (original documents) and generates the file data FL different from the document data DP. Specifically, out of the plurality of pages ranging from the first page to the N-th page (the last page) contained in the document data DP, extracted are only two pages, i.e., the second page corresponding to the electronic sticky note data DZ1 and the fifth page corresponding to the electronic sticky note data DZ2. Then, among the two extracted pages, the electronic sticky note data DZ1 is associated with the first page PN1 (i.e., the “original second page”) and the electronic sticky note data DZ2 is associated with the last page PN2 (i.e., the “original fifth page”). The file data FL is so generated as to have such a constitution. With this, it is possible to easily generate a file constituted only of the noted pages which are extracted out of the plurality of pages contained in the document data DP.

Discussing in more detail, as shown in FIG. 14, with the page PN1 associated are not only the memo data DM1 but also the data accompanying the memo data DM1 (the new creation time data DT and the user information DU). With the page PN1, also associated is the corresponding page identifying information DH (indicating that the “corresponding page” is, for example, “the second page”).

Similarly, with the page PN2 associated are not only the memo data DM2 but also the new creation time data DT, the user information DU, and the corresponding page identifying information DH (indicating that the “corresponding page” is, for example, “the fifth page”).

In the first preferred embodiment, in the generated file data FL, the original page images and the text information of the memo data DM are arranged in such a layout as shown in FIG. 24. Discussing in more detail, in the first page PN1 of the file data FL, a page display area RD for displaying the image of the “original second page” therein is arranged on the left side of the center portion and a memo display area RE relating to the memo data DM1 is arranged therenext on the right side. Similarly, in the second (and the last) page PN2 of the generated file, a page display area RD for displaying the image of the “original fifth page” therein is arranged on the left side of the center portion and a memo display area RE relating to the memo data DMZ is arranged therenext on the right side.

The generated file data FL is managed for each user who performs the operation for attachment of the electronic sticky note data. Specifically, as shown in FIG. 16, each file data FL is stored in the private box 5d of the corresponding user (Step S35). For example, the file data FL generated by the operation of the user UA is stored in the private box 5d of the user UA. The file data FL generated by the operation of the user UB is stored in the private box 5d of the user UB.

Discussing in detail, the data management apparatus 10 (specifically, the file generation part 26) specifies the user who sends the request data DS and stores the generated file data FL into the private box of the specified user. The operation of specifying the user may be performed, for example, by using the user identifying information of a sender in the login state.

In the first preferred embodiment, as well as the file data FL, the request data DS is also grouped and stored in a private box of the corresponding user.

Herein, in the first preferred embodiment, the request data DS is sent from the portable terminal 70 to the data management apparatus 10 whenever necessary in response to the operation for attachment of the electronic sticky note which is performed on the portable terminal 70 of the listener UA or the like. In other words, the request data DS is sent from the portable terminal 70 to the data management apparatus 10 every time when the operation for attachment of the electronic sticky note is performed. In the processes shown in FIGS. 6 to 9, the operations of Steps S33, S34, and S35 are performed every time when the request data DS is sent.

Discussing in detail, first, when the request data DS relating to the second page is sent from the portable terminal 70A to the data management apparatus 10, the data management apparatus 10 determines “the second page” as the corresponding page (Step S33). Then, the data management apparatus 10 extracts the second page and generates and stores the file data FL on the extracted second page (Steps S34 and S35).

After that, when the request data DS relating to the fifth page is sent from the portable terminal 70A to the data management apparatus 10, the data management apparatus 10 determines the respective corresponding pages relating to the request data DS1 and DS2 (Step S33). Then, the data management apparatus 10 extracts the corresponding pages (the second page and the fifth page) and generates and stores the file data FL containing the two extracted corresponding pages (the second page and the fifth page) (Steps S34 and S35). In order to avoid duplication of the processes, it is preferable that the file data FL generated by extracting the second page is held to be used, and the data generated by extracting the fifth page is added thereto, to thereby generate a new file data FL.

Thus, according to the request from the listening user UA, the file data FL in which the electronic sticky note is attached is generated. Similarly, according to the requests from other listening users UB, UC, . . . , the file data FL in each of which the electronic sticky note in attached are generated.

<1-6. Electronic Sticky Note Attachment Process (Search & Edit)>

In this system 100, it is also possible to change the content of the once inputted memo later at an appropriate point in time as well as to input the memo relating to each page in real time. Specifically, when the “search & edit” is selected in the menu screen GB2 (see FIG. 18), an edit operation can be performed. Especially, it is preferable that the “search & edit” should be selected after the presentation comes to the end of a section (for example, after the end of the presentation or in the intermission of the presentation), and so on. With this, even if it is hard to input a memo in real time since the presentation of the presenter PA proceeds relatively fast, it is possible to add a memo at an appropriate timing.

Specifically, when the user UA performs a manipulation to select a radio button corresponding to the “search & edit” and input the OK instruction (send instruction) in the menu screen GB2 (see FIG. 18), the portable terminal 70 sends a search request for the electronic sticky note (memo data and the like) to the data management apparatus 10.

Receiving the search request from the portable terminal 70, the data management apparatus 10 (specifically, the electronic sticky note controller 23) sends data of a search screen GB4 (see FIG. 20) to the portable terminal 70 (Steps S28 and S29). As a result, such a search screen GB4 as shown in FIG. 20 is displayed on the display part 77 of the portable terminal 70.

In the search screen GB4, the created electronic sticky notes (memos) are listed. Each electronic sticky note is displayed with the detailed information thereof (including, e.g., the corresponding page number and the new creation time). For example, it is indicated that the electronic sticky note in the uppermost row corresponds to the second page and is newly created at the time 13:35:10. Further, it is indicated that the electronic sticky note in the second row corresponds to the fifth page and is newly created at the time 13:38:20. The same applies to other electronic sticky notes. The indication is not limited to this, but the thumbnail image of the page may be also displayed in the search screen GB4.

Thus, in the search screen GB4 (see FIG. 20), when the user UA selects a radio button corresponding to a desired electronic sticky note and inputs the OK instruction (send instruction), the portable terminal 70 sends an “edit request” relating to the selected electronic sticky note to the data management apparatus 10.

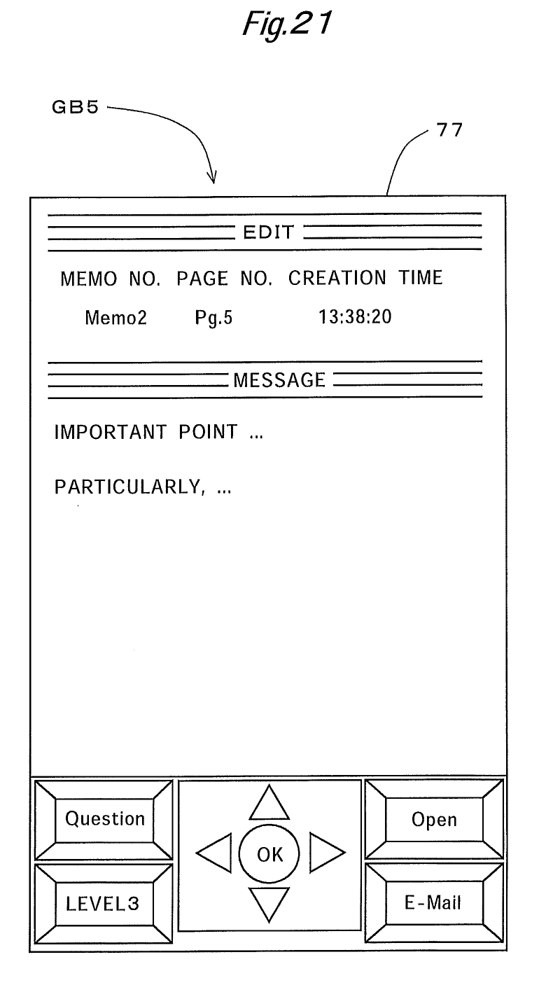

Receiving the edit request from the portable terminal 70, the data management apparatus 10 (specifically, the electronic sticky note controller 23) sends data of an edit screen GB5 (see FIG. 21) to the portable terminal 70 (Steps S30 and S31). Discussing in detail, the electronic sticky note data DZ (or the request data DS) relating to the selected electronic sticky note is sent to the data management apparatus 10. As a result, such an edit screen GB5 as shown in FIG. 21 is displayed on the display part 77 of the portable terminal 70.

On the upper side of the edit screen GB5, the detailed information on the electronic sticky note (memo) being currently edited is displayed. In FIG. 21, displayed is the detailed information indicating that the memo number is “Memo2”, the page number is “Pg5”, and the new creation time is “13:38:20”.

At the center of the edit screen GB5, provided is an input field for the content of the memo. In the input field, appropriate information can be inputted. For example, the words indicating “important” can be written. Additional information can be also inputted. Alternatively, a more detailed content of the question can be written.

When the user UA edits the content of the memo on the edit screen GB5 (see FIG. 21) and inputs the OK instruction (send instruction), the portable terminal 70 sends the request data DS (see FIG. 13) including the memo data (herein, text data) DM to the data management apparatus 10. At that time, in the sent request data DS, the memo data DM is updated with the edited content while the new creation time data DT and the like are not updated and have the same contents as those before editing.

Receiving and acquiring the request data DS form the portable terminal 70 via the network NW, the data management apparatus 10 executes the operations of Steps S33, S34, and S35. With this, the above-discussed operation of creating the file data FL and the like are performed. The request data DS to be changed in the storage part 5 is overwritten with the updated content of the received request data DS.

<1-7. Output Process>

After that, when the presenter PA closes the presentation and presses “END” button (not shown) on the display screen of the client 50 by manipulation of the mouse, the data management apparatus 10 determines that the presentation comes to an end.

When it is determined that the presentation comes to an end, the process goes from Step S39 to Step S40 (see FIG. 6).

In Step S40, an operation of sending the file data FL is performed. The data management apparatus 10 (specifically, the output destination controller 27) outputs the file data FL in which the electronic sticky note is attached to a specified output destination for each user.

When “E-mail” is specified as the output destination to which the file data FL is to be outputted, the output destination controller 27 sends the file data FL to a specified E-mail address via the network NW.

When “FAX (Facsimile)” is specified as the output destination to which the file data FL is to be outputted, the output destination controller 27 sends the page images contained in the file data FL to a facsimile machine having the specified FAX number via facsimile transmission.

When “box” is specified as the output destination to which the file data FL is to be outputted, the output destination controller 27 sends the file data FL to a specified box via the network NW. As the box serving as the output destination, the user's own box or other user's box provided in the data management apparatus 10 in advance, or the like, can be specified. Alternatively, any box in other MFP (different from the above data management apparatus 10) connected to the network NW can be specified.

When “print” is specified as the output destination to which the file data FL is to be outputted, the output destination controller 27 prints out the page images contained in the file data FL by using the printer 3 (see FIG. 2) of the data management apparatus 10.

Thus, the user can cause the generated file to be outputted (sent) to a desired output destination (send target). Therefore, the user can ensure great convenience. Herein, the term “output destination” refers to an output manner (or output type) such as “E-mail”, “facsimile” and the like and also refers to an output device (or target address) such as an “E-mail address”, a “facsimile machine” and the like.

The operation of specifying the output destination may be performed in advance before the execution of the processes shown in the flowcharts of FIGS. 6 to 8, like the above-discussed entry operation of the document data DP and the like. Discussing in detail, the host user has only to enter the output destination specified by each listener in the data management apparatus 10 in advance as part of the entry operation of the listener data.

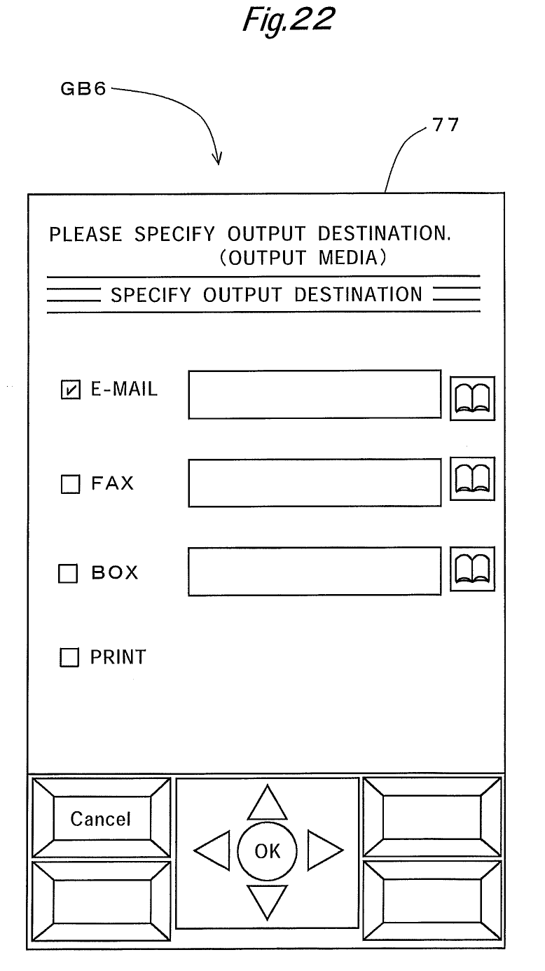

The specifying operation may be performed by each user. For example, each user may perform a predetermined manipulation to display such a screen GB6 as shown in FIG. 22 on the display part 77 of the portable terminal 70 and specify the output destination by using the screen GB6.

In the first preferred embodiment, each user can perform the operation of specifying (changing) the output destination during the presentation.

Specifically, in the menu screen GB2 shown in FIG. 18, when a radio button corresponding to the “change of output destination” is selected and the OK instruction (send instruction) is inputted, the portable terminal 70 sends an “output destination change request” to the data management apparatus 10.

On the other hand, receiving the output destination change request from the portable terminal 70, the data management apparatus 10 (specifically, output destination controller 27) sends data of an output destination specifying screen GB6 (see FIG. 22) to the portable terminal 70 (Steps S36 and S37). As a result, such an output destination specifying screen GB6 as shown in FIG. 22 is displayed on the display part 77 of the portable terminal 70.

The user UA can specify a desired output destination (output medium) by using the output destination specifying screen GB6. In order to specify E-mail as the output destination, for example, the user UA has only to use the operation input part 76 to mark a checkbox of the “E-mail” on the left end in the screen GB6 and input a character string indicating a specified E-mail address after change in the input field for E-mail address in the screen GB6. Alternatively, the user UA may cause address book information (list information) stored in the data management apparatus 10 (or the portable terminal 70) to be displayed on the display part 77 and select a desired E-mail address out of the list information to specify the output destination. The same applies to other output destinations (FAX, box, and the like).

Then, when the user UA inputs the OK instruction (send instruction), the portable terminal 70 sends “change information” on the output destination to the data management apparatus 10. Receiving the “change information” (including output destination specifying data) (Step S37), the data management apparatus 10 (specifically, the output destination controller 27) updates (determines) the output destination according to the change information.

Thus, it is also possible for each user to perform the operation of changing the specified output destination.

As discussed above, in the first preferred embodiment, the data management apparatus 10 receives the request data DS from the portable terminal 70 and determines the “sticky-note attachment object page” to which the electronic sticky note is to be attached on the basis of the page specifying data DF (specifically, the new creation time data DT). Then, the data management apparatus 10 generates the file data FL in which the electronic sticky note is attached to the sticky-note attachment object page. Discussing in detail, the file data FL in which the memo data DM is associated with the sticky-note attachment object page is generated. With this, the listening user has only to send the request data DS to the data management apparatus 10 by using the portable terminal 70, to thereby easily and reliably record the noted page (noted point). Especially, it is possible to easily and reliably associate the memo data with the corresponding page.

### 2. The Second Preferred Embodiment

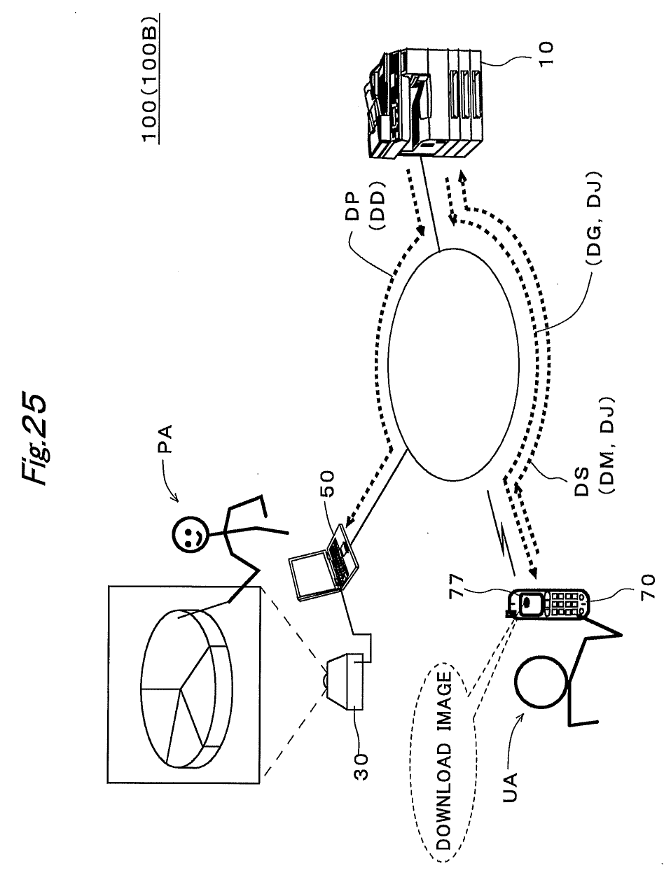

FIG. 25 is a diagram showing a presentation system 100 (100B) in accordance with the second preferred embodiment.

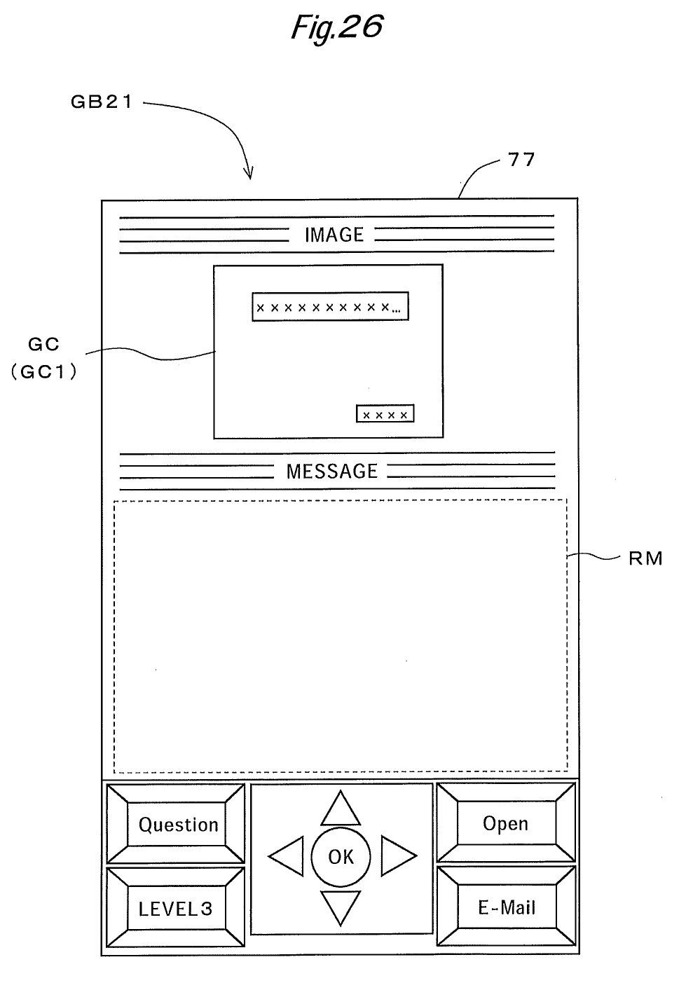

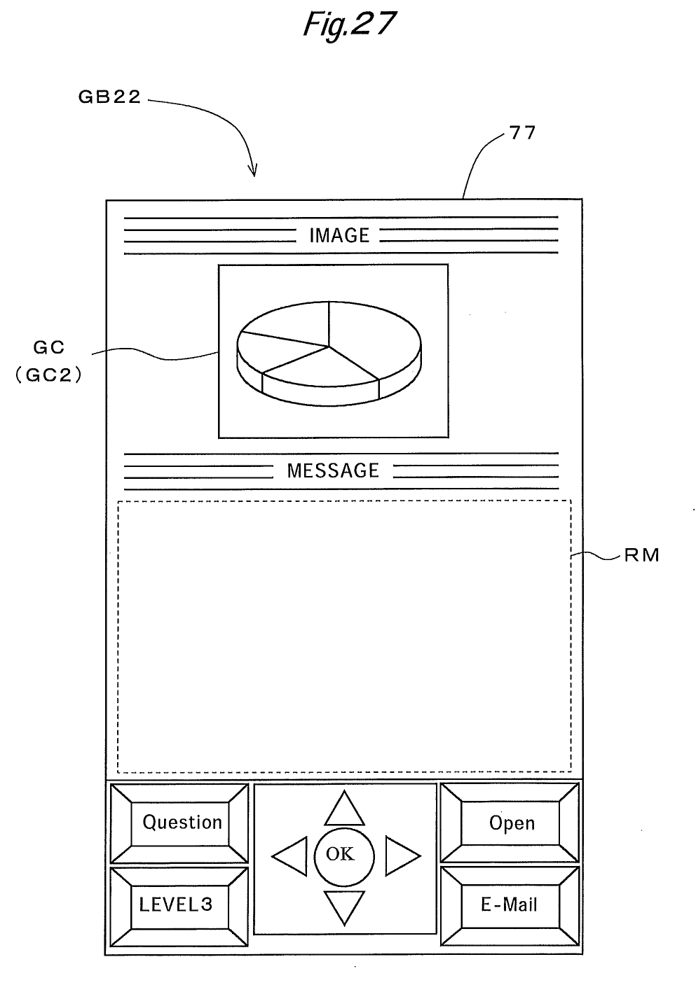

In the second preferred embodiment, as shown in FIG. 25, a page image displayed by using the display device 30 is downloaded from the data management apparatus 10 whenever necessary and displayed also on the portable terminal 70 (the display part 77) (also see FIGS. 26 and 27). In the state where the page image is displayed on the display part 77, the portable terminal 70 receives a creation request for an electronic sticky note and creates the memo data DM and the like. After that, the corresponding page identifying information DJ relating to the page displayed on the portable terminal 70 is sent to the data management apparatus 10 together with the memo data DM. Then, the data management apparatus 10 determines a page corresponding to the memo data DM (a sticky-note attachment object page to which the electronic sticky note is to be attached) on the basis of the corresponding page identifying information DJ. In the second preferred embodiment, the sticky-note attachment object page is determined not on the basis of the new creation time data DT, unlike in the first preferred embodiment. Therefore, the data management apparatus 10 does not need to generate the display period management table TB1 nor need to transmit the new creation time data DT to/from the portable terminal 70.

The second preferred embodiment is a variation of the first preferred embodiment, and the following discussion will be centered on the difference from the first preferred embodiment.

Detecting that the presenter PA starts the presentation, the data management apparatus 10 (also represented by 10B) of the second preferred embodiment sends image data DD (DD1) on the first page to the client 50. The data management apparatus 10B sends image data DG (DG1) on the first page also to each portable terminal 70 as well as the client 50. Each portable terminal 70 displays an image GC (GC1) relating to the first page on the display part 77 on the basis of the received data DG1 (see FIG. 26). At that time, the page displayed by the display device 30 via the client 50 is the same as the page (the first page) displayed on the display part 77 of the portable terminal 70. The data management apparatus 10 also sends the corresponding page identifying information DJ on the image data DG (specifically, the data indicating that the image data DG corresponds to “the first page”) to each portable terminal 70.

According to a page update instruction from the presenter PA, the data management apparatus 10 sends image data DD (DD2) on an updated page (the second page) to the client 50 and also sends image data DG (DG2) on the second page to each portable terminal 70. Each portable terminal 70 displays an image GC (GC2) relating to the second page on the basis of the received data DG2 (see FIG. 27). At that time, the page displayed by the display device 30 via the client 50 is the same as the page (the second page) displayed on the display part 77 of the portable terminal 70. The data management apparatus 10 also sends the corresponding page identifying information DJ on the image data DG (specifically, the data indicating that the image data DG corresponds to “the second page”) to each portable terminal 70.

The corresponding page identifying information DJ has only to be sent from the data management apparatus 10 to the portable terminal 70 as data different from download image DG. Sending of the corresponding page identifying information DJ, however, is not limited to this, but the corresponding page identifying information DJ may be sent from the data management apparatus 10 to the portable terminal 70 as part of the download image DG. There may be a case, for example, where the corresponding page identifying information DJ is included in a file name of the download image DG in a predetermined format and the portable terminal 70 extracts the corresponding page identifying information DJ from the file name of the download image DG.

After that, similarly, the data management apparatus 10 sends the image data on an updated page (the third page or the like) to the client 50 and each portable terminal 70 whenever necessary in response to the page update instruction from the presenter PA. On the display part 77 of the portable terminal 70 displayed is the same page as that displayed by the client 50 and the display device 30. The data management apparatus 10 also sends the corresponding page identifying information DJ on the image data DG to each portable terminal 70. In other words, each portable terminal 70 receives both the download image DG relating to the updated page and the corresponding page identifying information DJ on the page. Further, each portable terminal 70 associates the download image DG with the corresponding page identifying information DJ to manage them.

The page display controller 22 of the data management apparatus 10B controls such an operation (including the automatic update operation of the display part 77). The page display controller 22 controls the operation of switching the pages to be displayed by the display device 30 and further sends the image data DG on the page being displayed by the display device 30 (also referred to as a “currently displayed page”) and the page identifying information DJ on the currently displayed page in conjunction with the switching operation whenever necessary. The page display controller 22 can thereby display an image on the basis of the image data DG on the display part 77 of the portable terminal 70.

Considering that the image displayed on the portable terminal 70 is much smaller than the image displayed by the display device 30, the image displayed on the portable terminal 70 may have a resolution lower than that of the image displayed by the display device 30. Specifically, it is sufficient that the image sent from the data management apparatus 10 to the portable terminal 70 should have a resolution lower than that of the image sent from the data management apparatus 10 to the client 50. For this reason, herein, the data management apparatus 10 sends the images of relatively low resolution to the portable terminal 70. This can reduce the communication traffic.

As discussed above, the portable terminal 70 displays the image of the page being displayed (currently displayed page) by the display device 30 on the display part 77 (see FIG. 4) by using the image data sent from the data management apparatus 10 in conjunction with the above-discussed switching operation. In other words, the same page as the “currently displayed page” for the presentation using the display device 30 is displayed on the display part 77 almost in synchronization.

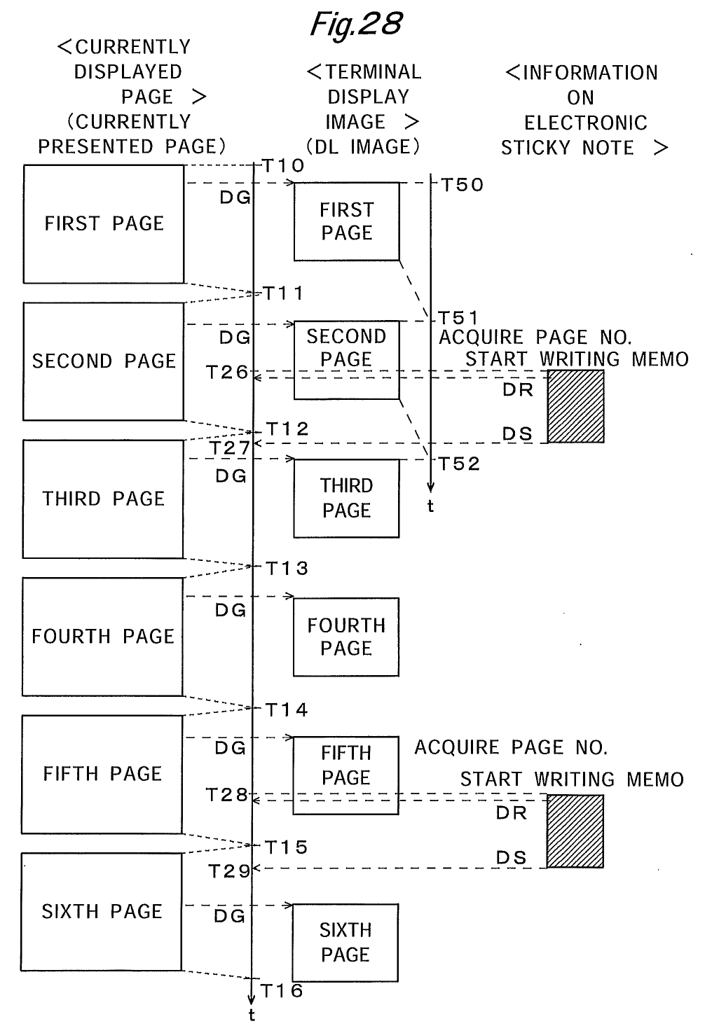

Considering the time required for transmission of the image data and the like, exactly, there arises a “difference” between the page being currently displayed by the display device 30 and the page being displayed on the display part 77. For example, the first page displayed by the display device 30 from the time T10 to the time T11 (see FIG. 28) is displayed on the display part 77 from a time T50 to a time T51 because of the time lag due to the image update. The time T50 is later than the time T10 (T50>T10) and the time T51 is later than the time T11 (T51>T11). In this case, during the period from the time T11 to the time T51, the page (the second page) being currently displayed by using the display device 30 is different from the page (the first page) displayed on the display part 77. As discussed later, however, since the listening user has only to input the new creation request for an electronic sticky note while checking the page displayed on the display part 77, the “difference” does not cause great trouble.

The portable terminal 70 receives the input of the new creation request for the electronic sticky note from the listening user in the state where the image of the “currently displayed page” is displayed on the display part 77. The input of the new creation request is received by the operation input part 76 and the input/output controller 73 (see FIG. 4).

FIGS. 26 and 27 are views showing exemplary display screens of the display part 77 of the portable terminal 70. FIG. 26 shows the state where the first page displayed by the display device 30 (from the time T10 to the time T11 (see FIG. 28)) is displayed on the display part 77 (from the time T50 to the time T51). FIG. 27 shows the state where the second page displayed by the display device 30 (from the time T11 to the time T12 (see FIG. 28)) is displayed on the display part 77 (from the time T51 to a time T52).

If the user UA has an intention of inputting the memo data on the second page, for example, the user UA manipulates cursor keys of the operation input part 76 of the portable terminal 70 to move the cursor to an input area RM for the message of the memo while the page image GC2 of the second page (see FIG. 27) is displayed on the display part 77. FIG. 28 shows the manner in which such a cursor key operation is performed at an arbitrary time T26 between the time T51 and the time T52. Herein, the manipulation of the cursor keys to move the cursor is also referred to as the “input of the new creation request” since it is an input operation for requesting the new creation of an electronic sticky note.

When the cursor key operation is performed to move the cursor, the portable terminal 70 comes into a “memo receiving mode” where the input of the memo is received and sends an automatic update interrupt request DR indicating that the automatic update of the image should be interrupted (see FIG. 28) to the data management apparatus 10.

Receiving the automatic update interrupt request DR from the portable terminal 70 (70A), the data management apparatus 10 interrupts an operation of automatically sending the image data to the portable terminal 70 (70A). This blocks the update of the image displayed on the portable terminal 70 (70A) of the user UA. During the input of the memo, the image of the page to which the memo is to be attached continues to be displayed on the upper side of the display part 77 (see FIG. 27) while not being updated.

The user UA can input the memo of an appropriate message by using such a display screen GB22 as shown in FIG. 27. This screen GB22 is a screen for new creation of a memo like the memo input screen GB3 of the first preferred embodiment (see FIG. 19). In the second preferred embodiment, however, a memo new creation screen (GB21, GB22, . . . ) having a small image GC relating to the same page as the page being used in the presentation is always displayed on the display part 77 in advance. The manipulation of the cursor keys to move the cursor allows the input of the memo. With respect to a screen to which no message of the memo needs to be inputted (for example, the screen GB21), the user UA has only not to manipulate the cursor keys. Then, when the next screen GB22 (the screen containing the image of the page to which a message of the memo is to be inputted) is displayed on the display part 77 by the automatic update operation, the user UA has only to manipulate the cursor keys to move the cursor as discussed above. This makes it possible to input the memo.

After inputting the appropriate message of the memo by using the display screen shown in FIG. 27, when the user UA inputs the OK instruction (send instruction), the portable terminal 70 terminates the memo receiving mode and sends request data DSb to the data management apparatus 10.

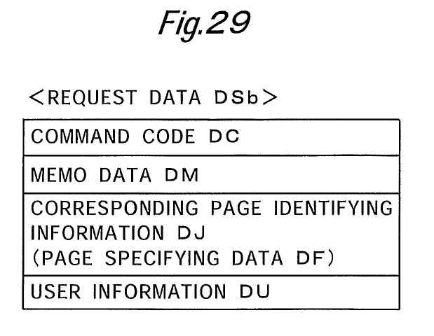

The request data DSb includes the corresponding page identifying information DJ as the page specifying data DF. Specifically, the request data DSb includes the command code DC, the memo data DM, the corresponding page identifying information DJ, and the user information (user identifying information) DU, as shown in FIG. 29. As compared with the request data DSa of FIG. 13, the request data DSb includes the corresponding page identifying information DJ, instead of the new creation time data DT, as the page specifying data DF.

The corresponding page identifying information DJ is information that the portable terminal 70 receives together with the download image GC relating to the page to which the memo is to be attached. For example, the corresponding page identifying information DJ includes information indicating that the page corresponding to the memo data DM being sent is “the second page”. The corresponding page identifying information DJ is also represented as page identifying information on the page displayed on the display part 77 of the portable terminal 70 at the time T26 when the portable terminal 70 receives the input of the new creation request for the electronic sticky note from the listening user.

The communication controller 71 of the portable terminal 70 (see FIG. 4) sends the request data DSb to the data management apparatus 10. Specifically, the communication controller 71 sends the corresponding page identifying information DJ which is the page identifying information on the “currently displayed page” being displayed on the display part 77 at the time T26 when the input of the new creation request is received.

Receiving the request data DSb, the data management apparatus 10 (the page determination part 25) determines the sticky-note attachment object page to which the electronic sticky note is to be attached on the basis of the corresponding page identifying information DJ included in the request data DSb. Specifically, the page determination part 25 determines that the electronic sticky note should be attached to the page (e.g., “the second page”) with the page number contained in the corresponding page identifying information DJ. In other words, the page determination part 25 determines that the memo data DM should be associated with the page (“the second page”).

Further, the data management apparatus 10 performs the generation of the file data FL in which the electronic sticky note (including the memo data DM) is associated with the second page, and the like, like in the first preferred embodiment.

After that, the data management apparatus 10 resumes the operation of automatically updating the image data. Discussing in detail, the data management apparatus 10 sends the image data DG on the currently displayed page (e.g., the third page) being displayed by the display device 30 at the resumption and the page identifying information DJ on the currently displayed page to the portable terminal 70 whenever necessary. The portable terminal 70 displays the image and the like on the basis of the image data DG on the display part 77.

After that, the same operation as discussed above will be repeatedly performed.

Thus, in the second preferred embodiment, the user can easily and reliably record the page to be noted only by using the portable terminal 70 to send the memo data to the data management apparatus 10. Especially, it is possible to easily and reliably associate the memo data with the corresponding page.

Particularly when the image of the page to which the memo needs to be attached is displayed on the display part 77 of the portable terminal 70, the user UA can give an instruction to attach the memo to the page by inputting the new creation request for the electronic sticky note (by moving the cursor to the input area RM for the message of the memo). At the point in time when the input of the new creation request for the electronic sticky note is received, since the image of the page to which the memo is to be attached is displayed on the display part 77 of the portable terminal 70, it is possible to grasp by intuition which page the memo and the like (electronic sticky note) being inputted is associated with. Further, since the image of the page with which the memo being inputted should be associated is displayed at the position near the input area RM for the memo, it is possible to very easily to grasp the correspondence.

### 3. The Third Preferred Embodiment

The third preferred embodiment is a variation of the first preferred embodiment, and the following discussion will be centered on the difference from the first preferred embodiment.

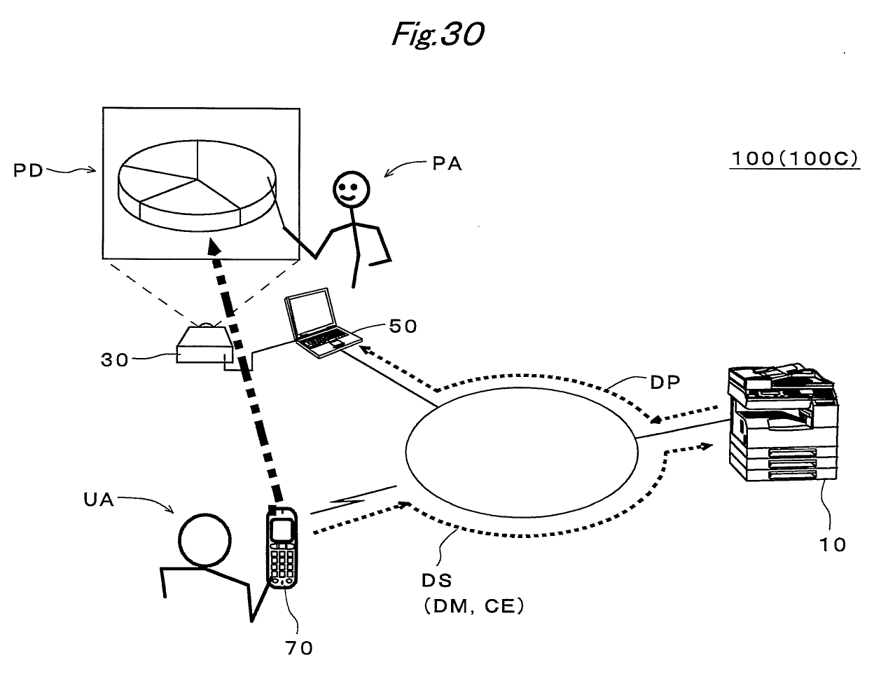

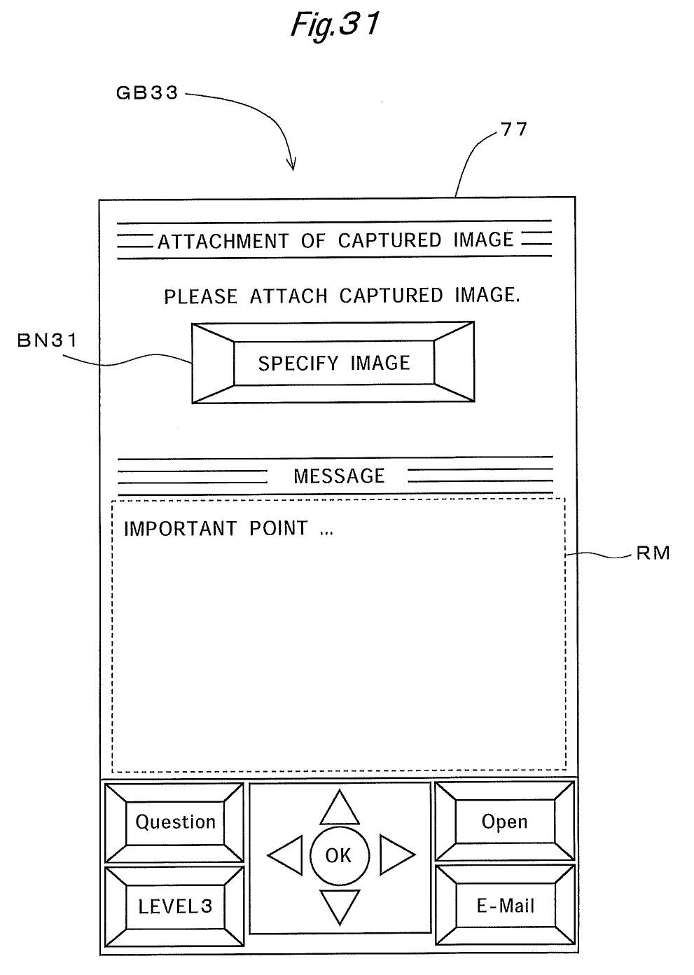

In the third preferred embodiment, as shown in FIG. 30, the user (listener) UA captures a page image PD being displayed in the presentation of the presenter PA by the portable terminal 70. The user UA sends the request data DS for requesting attachment of the electronic sticky note on the page image PD being displayed to the data management apparatus 10 by using the portable terminal 70. The request data DS includes the memo data DM relating to the page image PD being displayed and an image CE captured by the portable terminal 70. Receiving the request data DS, the data management apparatus 10 determines the sticky-note attachment object page to which the electronic sticky note is to be attached on the basis of the captured image CE and generates the file data FL in which the electronic sticky note is attached to the sticky-note attachment object page. More specifically, generated is the file data FL in which the memo data DM is associated with the sticky-note attachment object page. Also in such a manner, it is possible to easily and reliably record the page to be noted.

Also in the third preferred embodiment, the presenter PA can cause the presentation to proceed in the same manner as in the first preferred embodiment.

The data management apparatus 10 (also represented by 10C) of the third preferred embodiment sends the image data on each of the pages contained in the document data DP to the client 50 in response to a display update request from the presenter PA whenever necessary, like in the first and second preferred embodiments. On the other hand, the data management apparatus 10 does not send the image data (DG) on each page to the portable terminal 70 even if it receives the display update request from the presenter PA. In this respect, the operation manner is like that of the first preferred embodiment and different from that of the second preferred embodiment.

While the page image (the image for presentation) PD to which the memo needs to be attached is being displayed by the display device 30, the user UA captures the page image PD by using an image capturing part (digital camera) incorporated in the portable terminal 70. The image (captured image or picked-up image) CE obtained by capturing (or picking up) the page image PD is thereby acquired as a digital data file and once stored in a storage part folder inside the portable terminal 70.

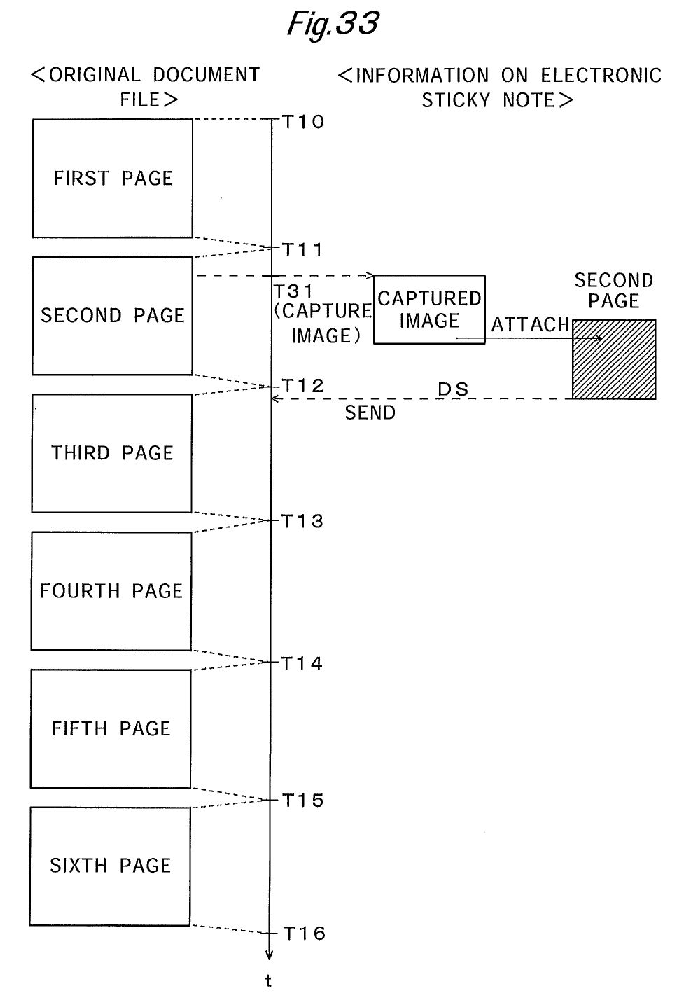

As shown in the timing chart of FIG. 33, for example, a captured image CE1 of “the second page” being displayed by the display device 30 is acquired at a time T31 (T11<T31<T12).

After that, the user UA accesses the data management apparatus 10 again by using the portable terminal 70, to thereby display the menu screen GB2 (see FIG. 18) on the display part 77 of the portable terminal 70. Then, the user UA selects the “new creation” in the menu screen GB2.

Receiving the “new creation request” from the portable terminal 70, the data management apparatus 10 sends data of a screen GB33 for new creation of a memo to the portable terminal 70. As a result, such a memo input screen GB33 as shown in FIG. 31 is displayed on the display part 77 of the portable terminal 70.

The memo input screen GB33 has the input area RM for a message of the memo at the center of the screen and has an image specifying button BN31 on the upper side of the screen.

The user UA inputs appropriate memo data in the input area RM by using the operation input part 76 of the portable terminal 70. Further, the user UA presses the image specifying button BN31 on the upper side to display an image specifying screen of folder tree type (not shown) on the display part 77 and selects the captured image CE in the storage part folder by using the image specifying screen.

When the user UA inputs the OK instruction (send instruction), the portable terminal 70 sends request data DSc including the inputted memo data DM to the data management apparatus 10.

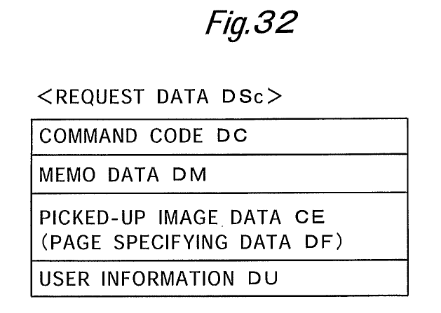

The request data DSc includes the command code DC, the memo data DM, the captured image data (also referred to as a “captured image”) CE, and the user information (user identifying information) DU, as shown in FIG. 32. As compared with the request data DSa of FIG. 13, the request data DSc includes the captured image data CE, instead of the new creation time data DT, as the page specifying data DF. The captured image data CE indicates an image captured by the portable terminal 70 as the image relating to the page to which the memo is to be attached. Out of the plurality of pages contained in the document data DP, for example, the captured image of “the second page” being currently displayed by the display device 30 is provided as the captured image data CE (page specifying data DF).

On the other hand, the data management apparatus 10 (specifically, the data acquisition part 24) receives and acquires the request data DSc from the portable terminal 70 via the network NW. Further, the data management apparatus 10 (specifically, the page determination part 25) determines the “sticky-note attachment object page” on the basis of the received request data DSc.

Herein, the data management apparatus 10C of the third preferred embodiment stores a plurality of images (page images) relating to the plurality of pages in the storage part 5 (specifically, the document data storage part 5a) in advance. Each of the plurality of page images corresponds to any one of the plurality of pages contained in the document data DP. Then, the data management apparatus 10 compares the received captured image CE with the plurality of page images stored in the data management apparatus 10 and determines the page corresponding to the captured image CE (sticky-note attachment object page) on the basis of the comparison result. Discussing in more detail, the page determination part 25 selects an image which is judged to be closest to the captured image CE out of the plurality of pages contained in the document data DP by pattern matching. Then, the page determination part 25 determines the page corresponding to the selected page image as the “sticky-note attachment object page”.

After that, the data management apparatus 10 (specifically, the file generation part 26) generates the file data FL in which the memo data DM is associated with the “sticky-note attachment object page” determined by the page determination part 25.

Also in such a manner as above, the user can easily and reliably record the page to be noted only by using the portable terminal 70 to send the memo data to the data management apparatus 10. Especially, it is possible to easily and reliably associate the memo data with the corresponding page.

### 4. The Fourth Preferred Embodiment

The fourth preferred embodiment is a variation of the third preferred embodiment. In the third preferred embodiment, discussion has been made on the exemplary case where the captured image CE is sent, being attached to the memo data DM. In the fourth preferred embodiment, discussion will be made on a technique in which the portable terminal 70 recognizes two-dimensional bar code information BM included in the captured image CE in which a two-dimensional bar code is captured and sends the recognition result (the two-dimensional bar code information BM) together with the memo data DM to the data management apparatus 10.

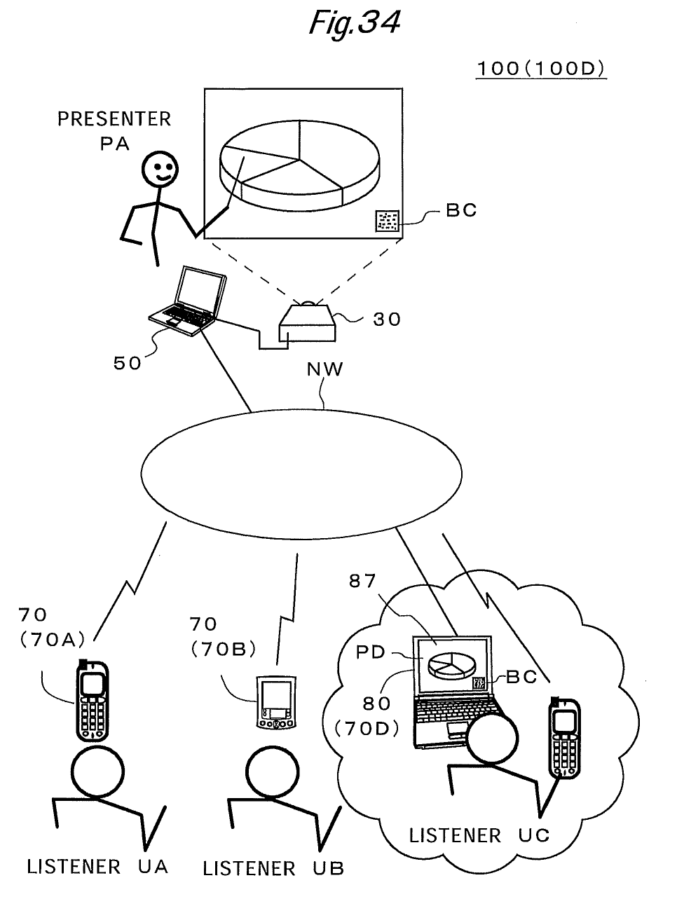

Herein, discussion will be made, assuming a case where the user UC at a remote place (see FIG. 34) visually recognizes the pages contained in the document for presentation by using a display device of a client computer 80.

While the image (image for presentation) PD of the page to which an electronic sticky note needs to be attached is displayed by the client computer 80, the user UC takes photograph of the page image PD by using the image capturing part of the portable terminal 70. As shown in FIG. 34, the page image PD is displayed on a display part 87 of the client 80, and the two-dimensional bar code BC is displayed in the lower right portion thereof, being superimposed on the page image PD. The two-dimensional bar code BC has page identifying information DK on the page being displayed on the client 80 (e.g., data indicating that the page being displayed on the client 80 is “the second page”). An operation of superimposing the two-dimensional bar code BC on the page image has only to be performed by the data management apparatus 10 in advance, and the data management apparatus 10 thereby sends the page image after the superimposition to the client 80. The operation is not limited to this, but there may be a case where the data management apparatus 10 sends the page identifying information DK together with the page image to the client 80 and the client 80 performs the superimposition.

In the fourth preferred embodiment, the captured image CE is acquired as an image including the two-dimensional bar code BC. In order to increase the rate in recognition of the two-dimensional bar code BC, it is preferable that the two-dimensional bar code BC should be captured, being relatively large, in the captured image CE. For example, it is desirable that the image in which the two-dimensional bar code exists over almost entire effective capture range thereof should be captured.

The portable terminal 70 performs image recognition of the captured image CE and extracts the information (two-dimensional bar code information) BM included in the two-dimensional bar code BC out from the captured image CE. Then, the portable terminal 70 sends request data DSd including the recognized two-dimensional bar code information BM (including the page identifying information DK), the memo data DM and the like to the data management apparatus 10.

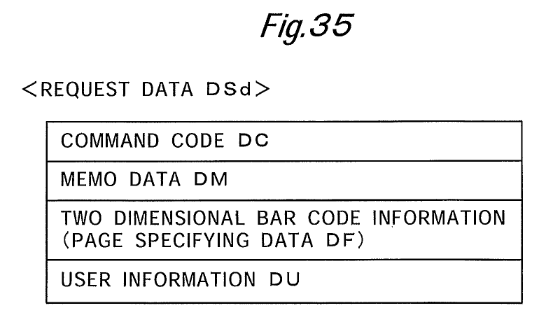

The request data DSd includes the command code DC, the memo data DM, the two-dimensional bar code information BM, and the user information DU, as shown in FIG. 35. As compared with the request data DSa of FIG. 13, the request data DSd includes the two-dimensional bar code information BM, instead of the new creation time data DT, as the page specifying data DF. The two-dimensional bar code information BM includes the page identifying information DK extracted out from the two-dimensional bar code BC contained in the image captured by the portable terminal 70. The page identifying information DK is page identifying information on the page shown in the captured image CE. For example, the two-dimensional bar code information (recognition result) BM includes information indicating that the captured image CE is the image on “the second page”, i.e., indicating that the electronic sticky note should be attached to “the second page”. In other words, the two-dimensional bar code information BM includes information indicating that the memo data DM is memo data on “the second page”.

On the other hand, when the data management apparatus 10 (specifically, the data acquisition part 24) receives and acquires the request data DSd from the portable terminal 70 via the network NW, the data management apparatus 10 determines the “sticky-note attachment object page”.

Specifically, the data management apparatus 10 determines the “corresponding sticky-note attachment object page” with which the memo data DM is to be associated, on the basis of the received two-dimensional bar code information BM. For example, when “the second page” is included as the two-dimensional bar code information BM, “the second page” of the document data DP is determined as the corresponding page with which the memo data DM is to be associated.

After that, the data management apparatus 10 (specifically, the file generation part 26) generates a file in which the memo data DM is associated with the corresponding page determined by the page determination part 25.

Also in such a manner as above, the user can easily and reliably record the page to be noted only by using the portable terminal 70 to send the memo data to the data management apparatus 10. Especially, it is possible to easily and reliably associate the memo data with the corresponding page.

Though the case where the portable terminal 70 captures the page image PD of the client 80 to thereby acquire the two-dimensional bar code information BM is discussed herein, the fourth preferred embodiment is not limited to this case. There may be a case, for example, where the portable terminal 70 captures the page image PD projected on a screen (the image displayed by the display device 30) to thereby acquire the two-dimensional bar code information.

### 5. Variations

Though the preferred embodiments of the present invention have been discussed above, the present invention is not limited to the above-discussed cases.

Though, for example, the portable terminal device (portable terminal 70) has been discussed as an exemplary terminal device in the above preferred embodiments, the terminal device is not limited to this type but may be a fixed terminal device. Discussing in more detail, a fixed terminal device (a personal computer or the like) provided in the meeting place for presentation may be used. Further, though the MFP has been discussed as an exemplary data management apparatus, the data management apparatus is not limited to this, but a general server computer or the like, for example, may be used.

Though the case has been discussed where the text data is used as memo data DM in the above preferred embodiments, the memo data is not limited to this type, but voice data (voice memo) or the like may be used as the memo data DM.

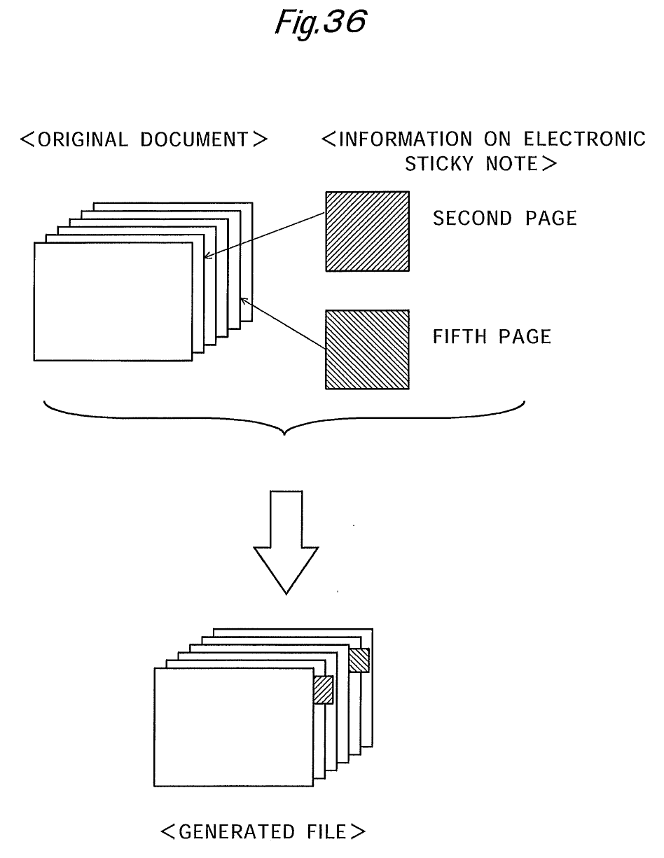

Though the case has been discussed where only the “corresponding page” of each memo data MD (only the sticky-note attachment object page to which the electronic sticky note is to be attached) is extracted to generate the file data FL in the above preferred embodiments, this is only an exemplary case. As shown in FIG. 36, for example, the memo data DM may be associated with the corresponding page while all the pages contained in the original document data DP are left. The memo data DM associated with the “corresponding page” may be displayed in such a manner that the memo data DM is attached to the corresponding page as shown in FIG. 36.

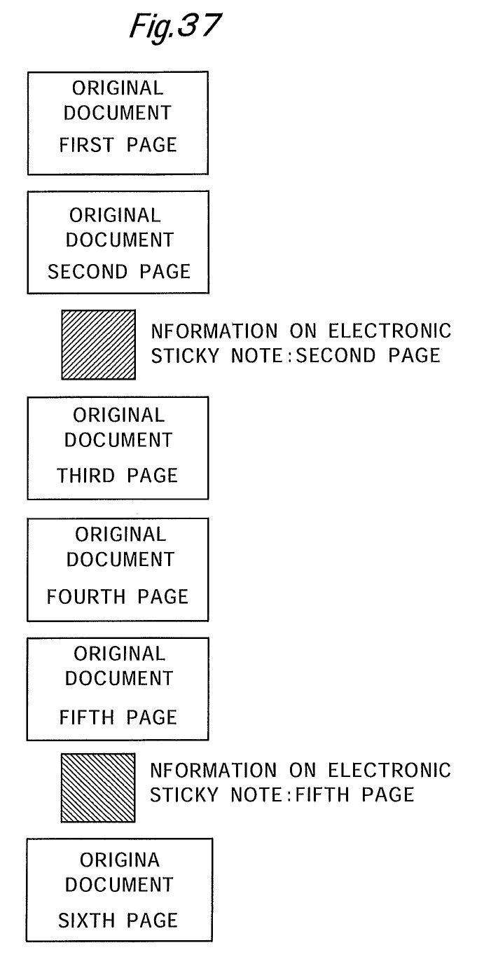

Though the case has been discussed where the page display area RD and the memo display area RE are arranged in each page of the file data FL as shown in FIG. 24 in the above preferred embodiments, the file layout is not limited to this case. As shown in FIG. 37, for example, a file in which an electronic sticky note page (text memo page) is inserted among the plurality of successive pages in the original document data DP may be used as the file data FL. FIG. 37 shows an exemplary layout in which the “electronic sticky note page” is inserted in such a manner as shown in FIG. 36. Discussing in more detail, the electronic sticky note page corresponding to the second page is arranged as a new third page and the original third page is arranged as a new fourth page. The same applies to the following pages to be pushed back. FIG. 37 shows the manner in which the pages arranged after insertion of the electronic sticky note page (i.e., the pages in a new file data FL) are arranged from top to bottom in the sequence of new page numbers.

Though the case has been discussed where the request data DS is sent from the portable terminal 70 to the data management apparatus 10 in response to the operation of the listening user for attachment of the electronic sticky note on the portable terminal 70 and the data management apparatus 10 performs generation of the file data FL and the like at every transmission of the request data DS in the above preferred embodiments, this is only an exemplary case.

There may be a case, for example, where after the presentation is finished, a plurality of request data DS are sent from the portable terminal 70 to the data management apparatus 10 by one operation and the file data FL are collectively generated on the basis of the plurality of request data DS.

Discussing in more detail, during the presentation, as the listening users perform the operations for attachment of a plurality of electronic sticky notes, the portable terminal 70 generates each request data DS according to each attachment operation. The portable terminal 70, however, does not send each request data DS to the data management apparatus 10. After all the respective operations for attachment of the plurality of electronic sticky notes are finished (for example, after the presentation is finished) the portable terminal 70 sends the plurality of request data DS according to the plurality of attachment operations to the data management apparatus 10 by one operation. For example, after the operation of attaching an electronic sticky note to the second page and the operation of attaching an electronic sticky note to the fifth page are performed, all the request data DS (the request data DS on the second page and the request data DS on the fifth page) are sent from the portable terminal 70 to the data management apparatus 10 by one operation.

On the other hand, the data management apparatus 10 receives the plurality of request data DS between Step S39 to Step S40 in FIG. 6. Specifically, the data management apparatus 10 receives the plurality of request data DS generated by the plurality of operations for attaching the plurality of electronic sticky notes from the portable terminal 70 by one operation after all the attachment operations are finished. Next, the data management apparatus 10 determines the corresponding page on each request data DS while performing generation of the file data FL, and so on. For example, the file data FL in which the electronic sticky notes are attached to the second page and the fifth page is thereby generated, as shown in FIG. 23 and the like.

With such an operation as above, the data management apparatus 10 does not need to perform the operations of Steps S33, S34, and S35 (see FIG. 8) during the presentation and this makes it possible to reduce the load of the data management apparatus 10 during the presentation. For example, the data management apparatus 10 does not need to generate the temporary file data FL in which the electronic sticky note is attached only to the second page. Further, even if the edit operation is frequently performed, the data management apparatus 10 does not need to generate the file data FL based on the memo data DM before the edit operation. Therefore, since unnecessary processes do not need to be executed, an efficient operation can be achieved.

There may be another case where the request data DS is sent from the portable terminal 70 to the data management apparatus 10 every time when the electronic sticky note is attached and after the presentation is finished, the file data FL is generated by one operation.

Though the case has been discussed where the file data FL is grouped and stored in any one of user-specific private boxes in real time in the above preferred embodiments, this is only an exemplary case.

There may be a case, for example, where a plurality of file data FL are once stored in the common box 5c (see FIG. 3) and after the presentation is finished, the plurality of file data FL are grouped and individually stored into the private boxes of the corresponding users.

Specifically, after the presentation is finished, the data management apparatus 10 specifies a listening user who requests the attachment of the electronic sticky note with respect to each file data FL on the basis of the user information DU (see FIG. 14) included in the file data FL. Herein, the user information DU is information on a listening user who requests the attachment of the electronic sticky note and included in each of the plurality of file data FL. Discussing in more detail, the user information DU included in each electronic sticky note data DZ. The data management apparatus 10 groups the plurality of file data FL by the listening users who request the attachment operations according to the user information DU of the file data FL. Discussing in detail, the data management apparatus 10 has only to store each file data FL into the private box 5d corresponding to the listening user who requests the related attachment operation. Herein, it is assumed that each file data FL is generated for the specific listening user who requests the attachment operation.

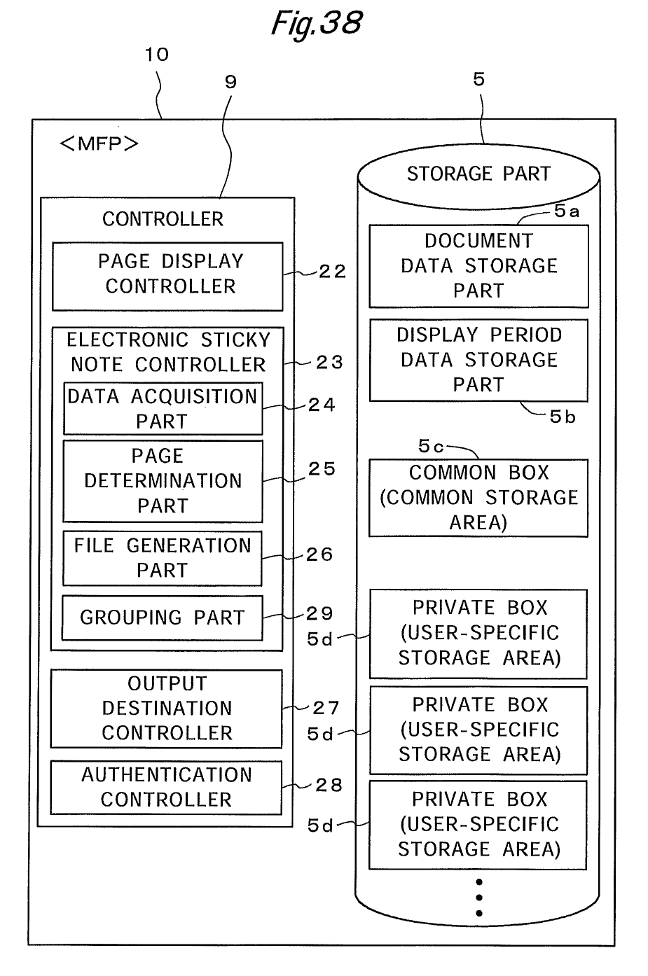

Thus, the data management apparatus 10 may also group and store the plurality of file data FL into the corresponding user-specific storage areas on the basis of the user information DU attached to each of the plurality of file data FL as the electronic sticky note. Since the grouping operation is performed after the presentation is finished, it is possible to reduce the load of the data management apparatus 10 during the presentation. Such a grouping operation may be performed by a grouping part 29 in the data management apparatus 10 (see FIG. 38).

Though the case has been discussed where the file data FL is outputted to the specified output destination immediately after the presentation is finished in the above preferred embodiments, this is only an exemplary case. The data management apparatus 10 may output the file data FL to the specified output destination, for example, when a predetermined period (e.g., one hour) elapses after the presentation is finished.

Though the case has been discussed where the request data DS (see FIG. 13) includes the memo data DM, the page specifying data DF, and the user information DU in the above preferred embodiments, the constitution of the request data DS is not limited to this type. For example, the request data DS may not include the memo data DM. In other words, the request data DS may also be data for requesting electronic (pseudo) attachment of only the electronic sticky note to any one page in the document data DP. Alternatively, the request data DS may not include the user information DU.

The same applies to the electronic sticky note data DZ (see FIG. 14) to be attached to the sticky-note attachment object page in the document data DP. For example, the electronic sticky note data DZ may not include the memo data DM. In other words, the electronic sticky note data may also be data for electronically (pseudoly) attaching only the electronic sticky note to any one page in the document data DP. Alternatively, the electronic sticky note data DZ may not include the user information DU.

Though the case has been discussed where the display start time and the display stop time of each page and the new creation time of each memo data DM are recorded in units of one second in the first preferred embodiment, this is only an exemplary case. For example, these times may be recorded in units of very small time smaller than one second (e.g., in units of one tenth of a second or one hundredth of a second). This allows more accurate determination of the corresponding page.

While the invention has been shown and described in detail, the foregoing description is in all aspects illustrative and not restrictive. It is therefore understood that numerous modifications and variations can be devised without departing from the scope of the invention.

What is claimed is:

1. A presentation system comprising:
a data management apparatus for storing document data for presentation therein;
a display device for displaying a plurality of pages contained in said document data; and
a terminal device capable of performing network communication with said data management apparatus, which sends request data for requesting attachment of an electronic sticky note to said document data to said data management apparatus via said network communication according to an input from a listening user of said presentation,
wherein said data management apparatus has
an acquisition part for acquiring said request data from said terminal device via said network communication;
a determination part for determining a sticky-note attachment object page out of said plurality of pages, to which said electronic sticky note is to be attached, on the basis of page specifying data included in said request data; and
a generation part for generating a file in which said electronic sticky note is attached to said sticky-note attachment object page determined by said determination part.

2. The presentation system according to claim 1, wherein
said terminal device is a portable terminal device.

3. A data management apparatus capable of performing network communication with a terminal device, comprising:
a document data storage part for storing document data for presentation therein;
an acquisition part for acquiring request data for requesting attachment of an electronic sticky note to said document data from said terminal device via said network communication;
a determination part for determining a sticky-note attachment object page out of a plurality of pages contained in said document data, to which said electronic sticky note is to be attached, on the basis of page specifying data included in said request data; and
a generation part for generating a file in which said electronic sticky note is attached to said sticky-note attachment object page determined by said determination part.

4. The data management apparatus according to claim 3, further comprising
a display period data storage part for storing display period data indicating a display period for each of said plurality of pages displayed by a display device for presentation,
wherein said page specifying data has new creation time data indicating a new creation time of said request data, and
said determination part determines said sticky-note attachment object page on the basis of said new creation time data and said display period data.

5. The data management apparatus according to claim 4, wherein
said determination part determines said sticky-note attachment object page on the basis of a result of a judgment specifying a display period which includes said new creation time of said request data out of a plurality of display periods corresponding to said plurality of pages.

6. The data management apparatus according to claim 3, further comprising
a display controller for controlling a switching operation among pages to be displayed by a display device for presentation and sending image data of a currently displayed page which is a page being currently displayed by said display device and page identifying information of said currently displayed page to said terminal device in conjunction with said switching operation, to thereby display an image based on said image data on a display part,
wherein said page specifying data includes corresponding page identifying information which is page identifying information on a page displayed on said display part of said terminal device by using said image data at the point in time when said terminal device receives an input of new creation request for an electronic sticky note from a listening user, and
said determination part determines said sticky-note attachment object page on the basis of said corresponding page identifying information.

7. The data management apparatus according to claim 3, wherein
said page specifying data has a captured image on any one of said plurality of pages displayed by a display device for presentation,
said document data storage part has a plurality of page images corresponding to said plurality of pages, respectively, and
said determination part determines said sticky-note attachment object page on the basis of a result of comparison between said captured image and said plurality of page images.

8. The data management apparatus according to claim 3, wherein
said page specifying data has two-dimensional bar code information extracted from a captured image obtained by capturing an image of a page including a two-dimensional bar code, which is a page displayed by a display device for presentation,
said two-dimensional bar code information includes page identifying information on a page shown in said captured image, and
said determination part determines said sticky-note attachment object page on the basis of said page identifying information.

9. The data management apparatus according to claim 3, wherein
said request data includes memo data, and
said generation part associates said memo data with said sticky-note attachment object page as data of said electronic sticky note in said file.

10. The data management apparatus according to claim 9, wherein
said memo data includes text data.

11. The data management apparatus according to claim 9, wherein
said memo data includes voice data.

12. The data management apparatus according to claim 3, wherein
said generation part generates said file by extracting said sticky-note attachment object page out of said plurality of pages.

13. The data management apparatus according to claim 3, wherein
said acquisition part receives said request data transmitted from said terminal device in response to an attachment operation of said electronic sticky note performed by a listening user on said terminal device.

14. The data management apparatus according to claim 3, wherein
said acquisition part receives a plurality of request data including said request data, which are generated by a plurality of attachment operations of said plurality of electronic sticky notes, from said terminal device by one operation after said plurality of attachment operations are finished.

15. The data management apparatus according to claim 3, further comprising
a grouping part for grouping a plurality of files in which said electronic sticky notes are attached on the basis of a plurality of request data from a plurality of listening users,
wherein said plurality of files each have user information on a listening user who requests said electronic sticky note, and
said grouping part groups said plurality of files on the basis of said user information and stores each of said plurality of files into a specific storage area of the corresponding listening user.

16. The data management apparatus according to claim 3, further comprising
an output destination controller for determining an output destination for said file on the basis of output destination specifying data transmitted from said terminal device.

17. A computer-readable recording medium for storing a program executed by a computer which is capable of performing network communication with a terminal device to cause said computer to perform the steps of:
a) acquiring request data for requesting attachment of an electronic sticky note to document data for presentation from said terminal device via said network communication;
b) determining a sticky-note attachment object page out of a plurality of pages contained in said document data, to which said electronic sticky note is to be attached, on the basis of page specifying data included in said request data; and
c) generating a file in which said electronic sticky note is attached to said sticky-note attachment object page determined in said step b).
